(19) United States
(12) Patent Application Publication
(10) Pub. No.: US 2026/0147312 A1
(43) Pub. Date: May 28, 2026

(54) OPTICAL DEVICE AND ELECTRONIC DEVICE INCLUDING THE SAME

(71) Applicants: Samsung Display Co., Ltd., Yongin-si (KR); THE BOARD OF TRUSTEES OF THE LELAND STANFORD JUNIOR UNIVERSITY, Stanford (CA)

(72) Inventors: Ji Won JUNG, Yongin-si (KR); Brian CHAO, Stanford, CA (US); Gordon WETZSTEIN, Stanford, CA (US); Manu GOPAKUMAR, Saratoga, CA (US); Gun Yeal LEE, Palo Alto, CA (US); Su Yeon CHOI, Redwood City, CA (US)

(21) Appl. No.: 19/294,129

(22) Filed: Aug. 7, 2025

Related U.S. Application Data
(60) Provisional application No. 63/726,098, filed on Nov. 27, 2024.

(51) Int. Cl. G03H 1/00; G02B 27/01

(52) U.S. Cl. CPC G03H 1/0005; G02B 27/0172; G02B 2027/0109; G02B 2027/0112; G02B 2027/0174; G03H 2001/0088

(57) ABSTRACT

An optical device and an electronic device including the same are provided. An optical device may include a light source including a plurality of first pixels configured to emit light, a polarization member configured to control polarization of light output from the light source, a spatial light modulator including a plurality of second pixels configured to display a light modulation pattern to modulate a phase of light passing through the polarization member, and a controller configured to control the plurality of first pixels and the plurality of second pixels based on an input image.

### CROSS-REFERENCE TO RELATED APPLICATION

This application claims priority to and the benefit of U.S. Provisional Application No. 63/726,098, filed on Nov. 27, 2024, in the United States Patent and Trademark Office, the entire disclosure of which is incorporated by reference herein.

### BACKGROUND

### 1. Field

The present disclosure relates to an optical device and an electronic device including the same.

### 2. Description of the Related Art

As the information society evolves, various display devices have been developed to display information. For example, an augmented reality (AR) device is a display device that superimposes a virtual image on a real-world image seen by the user's eyes. For another example, a three-dimensional (3D) image display device separately displays a left-eye image and a right-eye image in order to give a viewer 3D experiences using binocular parallax.

For augmented reality devices or 3D image display devices, laser has been mainly used as a light source because it is easy to manipulate the wavefront. Unfortunately, lasers have poor color gamut, and noise is generated due to constructive interference, such as speckle. Therefore, a device with improved color gamut and noise issues is desired.

### SUMMARY

Aspects and features of embodiments of the present disclosure provide an optical device with improved color gamut and noise issues.

Aspects and features of embodiments of the present disclosure also provide an electronic device including an optical device with improved color gamut and noise issues.

According to one or more embodiments of the present disclosure, an optical device may include a light source including a plurality of first pixels configured to emit light, a polarizer configured to control polarization of light output from the light source, a spatial light modulator including a plurality of second pixels configured to display a light modulation pattern to modulate a phase of light passing through the polarizer, and a controller configured to control the plurality of first pixels and the plurality of second pixels based on an input image.

According to one or more embodiments, the plurality of first pixels may be associated with the plurality of second pixels, respectively.

According to one or more embodiments, the controller may be further configured to generate target color data for each pixel color and target phase data for each pixel phase based on the input image, generate target hologram data including information on the color for each pixel and information on the phase for each pixel by combining the target color data with the target phase data, generate light intensity data for the color for each pixel and light modulation data for the phase for each pixel based on the target hologram data, control the light source based on the light intensity data, and control the spatial light modulator based on the light modulation data.

According to one or more embodiments, the controller may include an artificial neural network configured to generate the target phase data based on the target color data. The generating the target color data and the target phase data based on the input image may include extracting information on color for each pixel from the input image to generate the target color data, and inputting the target color data into the artificial neural network to generate target phase data including information on phase for each pixel as an output thereof.

According to one or more embodiments, the optical device may further include a sensor configured to detect a holographic image generated by modulating the phase by the spatial light modulator.

According to one or more embodiments, the controller may be further configured to train the artificial neural network using the target hologram data and a hologram image.

According to one or more embodiments, the training the artificial neural network may include supervised training the artificial neural network using the target hologram data as correct answer data.

According to one or more embodiments, the generating the light intensity data for the color for each pixel and the light modulation data for the phase for each pixel based on the target hologram data may include extracting the light intensity data including the color for each pixel from the target hologram data, and performing a function transformation on the target hologram data to generate the light modulation data including the light modulation pattern for the phase for each pixel.

According to one or more embodiments, each of the plurality of first pixels may include a first sub-pixel configured to emit a first light, a second sub-pixel configured to emit a second light, and a third sub-pixel configured to emit a third light. The controlling the light source based on the light intensity data may include determining an intensity of the first light emitted by the first sub-pixel, an intensity of the second light emitted by the second sub-pixel and an intensity of the third light emitted by the third sub-pixel according to the light intensity data.

According to one or more embodiments, the light source includes a display device that is configured to output incoherent light.

According to one or more embodiments, the light source includes an Organic Light-Emitting Diode on Silicon (OLEDoS) display device that includes an organic light-emitting layer located on a first semiconductor substrate.

According to one or more embodiments, the light source includes a Light-Emitting Diode on Silicon (LEDoS) display device that includes an inorganic light-emitting layer located on a second semiconductor substrate.

According to one or more embodiments, the spatial light modulator includes a Liquid Crystal on Silicon (LCoS) display device that includes a liquid-crystal layer located on a third semiconductor substrate.

According to one or more embodiments of the present disclosure, an optical device may include a first display device including first pixels configured to emit light of a first color, a second display device including second pixels configured to emit light of a second color different from the first color, a first reflection member configured to reflect light of the first color while transmitting light of other colors than the first color, a second reflection member configured to reflect light of the second color while transmitting light of other colors than the second color, a spatial light modulator including third pixels configured to display a light modulation pattern to modulate a phase of light passing through the first reflection member and the second reflection member, and a controller configured to control the first pixels, the second pixels and the third pixels based on an input image.

According to one or more embodiments, the first pixels, the second pixels and the third pixels may be associated with one another, respectively.

According to one or more embodiments, the controller may be further configured to generate target color data for each pixel color and target phase data for each pixel phase based on the input image, generate target hologram data including information on the color for each pixel and information on the phase for each pixel by combining the target color data with the target phase data, generate light intensity data for the color for each pixel and light modulation data for the phase for each pixel based on the target hologram data, control the first display device and the second display device based on the light intensity data, and control the spatial light modulator based on the light modulation pattern.

According to one or more embodiments, the generating the light intensity data for the color for each pixel and the light modulation data for the phase for each pixel based on the target hologram data may include extracting the light intensity data including the color for each pixel from the target hologram data, and performing a function transformation on the target hologram data, to generate the light modulation data including the light modulation pattern for the phase for each pixel.

According to one or more embodiments, the controlling the first display device and the second display device based on the light intensity data may include determining an intensity of the light of the first color emitted by a first pixel corresponding to a first position from among the first pixels and an intensity of the light of the second color emitted by a second pixel corresponding to a second position from among the second pixels according to the light intensity data.

According to one or more embodiments, the optical device may further include a first refraction member arranged between the first display device and the first reflection member, and configured to collimate light of the first color output from the first display device to provide the light to the first reflection member, and a second refraction member arranged between the second display device and the second reflection member, and configured to collimate light of the second color output from the second display device to provide the light to the second reflection member.

According to one or more embodiments of the present disclosure, an electronic device may include a light source including a plurality of first pixels configured to emit light, a spatial light modulator including a plurality of second pixels configured to display a light modulation pattern to modulate a phase of light output from the light source, a memory, and a processor. The processor is configured to generate light intensity data for the plurality of first pixels and light modulation data for the plurality of second pixels based on an input image.

These and other aspects and features of embodiments of the present disclosure will become apparent to those of ordinary skill in the art upon review of the Detailed Description and the Claims to follow.

According to one or more embodiments of the present disclosure, an optical device can improve the color gamut and the light efficiency while preventing noise due to constructive interference by employing an OLEDoS display device or an LEDoS display device as a light source instead of laser previously employed by existing devices.

Previously, RGB colors were driven sequentially within a single frame. In contrast, by using an OLEDoS display device or an LEDoS display device as the light source, RGB colors can be driven concurrently (e.g., simultaneously) within a single frame. By doing so, the response speed may be improved compared to the existing devices, allowing for displaying more realistic virtual images.

In one or more embodiments, unlike the existing manner of controlling the intensity and phase of light using only a spatial light modulator, it is possible to control the intensity of light using a light source and control the phase of light using a spatial light modulator. By independently controlling the intensity of light and the phase of light, a higher contrast ratio can be obtained compared to the existing devices.

In one or more embodiments of the present disclosure, it is possible to prevent chromatic aberration occurring during refraction by providing a plurality of light sources that emit light of different colors and a refraction member and a reflection member for each of the plurality of light sources. In this manner, the virtual images ultimately generated can become more realistic.

It should be noted that effects, aspects, and features of the present disclosure are not limited to those described above and other effects, aspects, and features of the present disclosure will be apparent to those skilled in the art from the following descriptions.

### BRIEF DESCRIPTION OF THE DRAWINGS

The above and other aspects and features of embodiments of the present disclosure will become more apparent by describing in detail embodiments thereof with reference to the attached drawings, in which:

FIG. 1 is a block diagram of an electronic device according to one or more embodiments of the present disclosure. ;

FIG. 2 is a view showing examples of electronic devices according to one or more embodiments of the present disclosure;

FIG. 3 is a view showing an example of an optical device according to one or more embodiments of the present disclosure;

FIG. 4 is a view for illustrating the light source, the spatial light modulator and the sensor of FIG. 3;

FIG. 5 is a flowchart for illustrating a method for operating an electronic device according to one or more embodiments of the present disclosure;

FIG. 6 is a flowchart for illustrating a step S100 of FIG. 5 in detail;

FIG. 7 is a view for illustrating target color data and target phase data of FIG. 6;

FIG. 8 is a view for illustrating an artificial neural network of a controller of an optical device according to one or more embodiments of the present disclosure;

FIG. 9 is a flowchart for illustrating a step S300 of FIG. 5 in detail;

FIG. 10 is a view for illustrating the light intensity data and light modulation pattern of FIG. 9;

FIG. 11 is a view for illustrating training of the artificial neural network of FIG. 8;

FIG. 12 is a view showing an example of an optical device according to one or more embodiments of the present disclosure;

FIG. 13 is an exploded, perspective view of a light source according to one or more embodiments of the present disclosure;

FIG. 14 is a view showing a layout of the display panel of FIG. 13;

FIG. 15 is an equivalent circuit diagram of a first sub-pixel according to one or more embodiments of the present disclosure;

FIG. 16 is a view showing a layout of a display panel according to one or more embodiments of the present disclosure;

FIG. 17 is a view showing a layout of the display area of FIG. 16;

FIG. 18 is a view showing a layout of the display area of FIG. 16;

FIG. 19 is a cross-sectional view of the display panel, taken along the line I1-I1′ of FIG. 17;

FIG. 20 is a cross-sectional view of the display panel, taken along the line I1-I1′ of FIG. 17.

### DETAILED DESCRIPTION

The aspects and features of embodiments of the present disclosure and methods of accomplishing the same may be understood more readily by reference to the detailed description of embodiments and the accompanying drawings. Hereinafter, the subject matter of the present disclosure will be described in more detail with reference to the accompanying drawings. The subject matter of the present disclosure, however, may be embodied in one or more suitable different forms and should not be construed as being limited to only the illustrated embodiments herein. Rather, these embodiments are provided as examples so that the present disclosure will be thorough and complete and will fully convey the aspects and features of the present disclosure to those skilled in the art. Accordingly, processes, elements, and techniques that are not necessary to those having ordinary skill in the art for a complete understanding of the aspects and features of the present disclosure may not be described.

Unless otherwise noted, like reference numerals, characters, and/or one or more (e.g., any suitable) combinations thereof refer to like elements throughout the accompanying drawings and the written description, and duplicative descriptions thereof may not be provided, and thus, descriptions thereof may not be repeated. Further, parts not related to the description of one or more embodiments may not be shown to make the description clear.

In the drawings, the relative sizes of elements, layers, and regions may be exaggerated for clarity. In one or more embodiments, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, and/or the like of the elements, unless specified.

One or more embodiments are described herein with reference to sectional illustrations that are schematic illustrations of embodiments and/or intermediate structures. As such, variations from the shapes of the illustrations as a result, for example, of manufacturing techniques and/or tolerances, may be expected. Further, specific structural or functional descriptions disclosed herein are merely illustrative for the purpose of describing certain embodiments according to the present disclosure. Thus, one or more embodiments disclosed herein should not be construed as being limited to the particular illustrated shapes of regions, but are to include deviations in shapes that result from, for instance, manufacturing.

For example, an implanted region illustrated as a rectangle (e.g., a substantially rectangle) may have rounded or curved features and/or a gradient of implant concentration at its edges rather than a binary change from implanted to non-implanted region. Likewise, a buried region formed or provided by implantation may result in one or more implantations in the region between the buried region and the surface through which the implantation takes place. Thus, the regions illustrated in the drawings are schematic in nature and their shapes are not intended to illustrate the actual shape of a region of a device and are not intended to be limiting. In one or more embodiments, as those skilled in the art may realize, the described embodiments may be modified in one or more suitable different ways, all without departing from the spirit and scope of the present disclosure.

In the present disclosure, for the purposes of explanation, one or more specific details are set forth to provide a thorough understanding of one or more suitable embodiments. It is apparent, however, that one or more suitable embodiments may be practiced without these specific details or with one or more equivalent arrangements. In other instances, one or more structures and devices that are generally available or generally used are shown in block diagram form to avoid unnecessarily obscuring one or more suitable embodiments.

Spatially relative terms, such as “beneath,” “below,” “lower,” “under,” “above,” “upper,” and/or the like, may be used herein for ease of explanation to describe one element or feature's relationship to another element(s) or feature(s) as illustrated in the drawings. It will be understood that the spatially relative terms are intended to encompass different orientations of the device in use or in operation, in addition to the orientation depicted in the drawings. For example, if (e.g., when) the device in the drawings is turned over, elements described as “below” or “beneath” or “under” other elements or features may then be oriented “above” the other elements or features. Thus, the example terms “below” and “under” may encompass both (e.g., concurrently (e.g., simultaneously)) an orientation of above and below. The device may be otherwise oriented (e.g., rotated 90 degrees or at other orientations) and the spatially relative descriptors used herein should be interpreted accordingly. Similarly, if (e.g., when) a first part is described as being arranged “on” a second part, this indicates that the first part is arranged at an upper side or a lower side of the second part without the limitation to the upper side thereof on the basis of the gravity direction.

Further, in the present disclosure, the phrase “on a plane” or “in a plan view” refers to viewing a target portion from the top, and the phrase “on a cross-section” refers to viewing a cross-section formed or provided by vertically cutting a target portion from the side.

It will be understood that if (e.g., when) an element, a layer, a region, or a component is referred to as being “formed on,” “arranged on,” “on,” “connected to,” or “coupled to” another element, layer, region, or component, it may be directly formed on, directly arranged on, directly on, directly connected to, or directly coupled to the other element, layer, region, or component, or indirectly formed on, indirectly arranged on, indirectly on, indirectly connected to, or indirectly coupled to the other element, layer, region, or component such that one or more intervening elements, layers, regions, or components may be present therebetween. For example, if (e.g., when) a layer, a region, or a component is referred to as being “electrically connected” or “electrically coupled” to another layer, region, or component, it may be directly electrically connected or coupled to the other layer, region, and/or component or intervening layers, regions, or components may be present therebetween. However, “directly connected/directly coupled” refers to one component directly connecting or coupling another component without an intermediate component present therebetween.

In one or more embodiments, other expressions describing relationships between components, such as “between,” “immediately between,” or “adjacent to,” and “directly adjacent to” may be construed similarly. In one or more embodiments, it will also be understood that if (e.g., when) an element or layer is referred to as being “between” two elements or layers, it may be the only element or layer between the two elements or layers, or one or more intervening elements or layers may also be present.

In the present disclosure, expressions, such as “at least one of,” “one of,” and “selected from among,” if (e.g., when) preceding a list of elements, modify the entire list of elements and do not modify the individual elements of the list. For example, “at least one of X, Y, and Z,” “at least one of X, Y, or Z,” and “at least one selected from among the group consisting of X, Y, and Z” may be construed as X only, Y only, Z only, a (e.g., any suitable) combination of two or more of X, Y, and Z, such as, for instance, XYZ, XYY, XZ, YZ, and ZZ, or a (e.g., any suitable) variation thereof. Similarly, the expression, such as “at least one of A and/or B” may include A, B, or A and B. As used herein, the term “and/or” includes any and all combinations of one or more of the associated listed items. For example, the expression, such as “A and/or B” may include A, B, or A and B. Further, the use of “may” if (e.g., when) describing embodiments of the present disclosure refers to “one or more embodiments of the present disclosure”.

It will be understood that, although the terms “first,” “second,” “third,” and/or the like may be used herein to describe one or more suitable elements, components, regions, layers, and/or sections, these elements, components, regions, layers, and/or sections should not be limited by these terms. These terms are used to distinguish one element, component, region, layer, or section from another element, component, region, layer, or section. Thus, a first element, a first component, a first region, a first layer, or a first section described herein may be termed a second element, a second component, a second region, a second layer, or a second section, without departing from the spirit and scope of the present disclosure.

In the examples, the x-axis, the y-axis, and/or the z-axis are not limited to three axes of a rectangular coordinate system and may be interpreted in a broader sense. For example, the x-axis, the y-axis, and the z-axis may be normal (e.g., perpendicular) to one another or may represent different directions that are not normal (e.g., perpendicular) to one another. The same applies for the first direction, the second direction, and/or the third direction.

The terminology used herein is for the purpose of describing particular embodiments only and is not intended to be limiting of the present disclosure. As used herein, the singular forms “a” and “an” are intended to include the plural forms as well, unless the context clearly indicates otherwise.

It will be further understood that the terms “have,” “having,” “includes,” and “including,” if (e.g., when) used in the present disclosure, specify the presence of the stated features, integers, steps, operations, elements, and/or components, but do not preclude the presence or addition of one or more other features, integers, steps, operations, elements, components, and/or groups thereof. For example, it should be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As used herein, the term “substantially,” “about,” “approximately,” and similar terms are used as terms of approximation and not as terms of degree and are intended to account for the inherent deviations in measured or calculated values that may be recognized by those of ordinary skill in the art. “About” or “approximately,” as used herein, is inclusive of the stated value and refers to as being within an acceptable range of deviation for the particular value as determined by one of ordinary skill in the art, considering the measurement in question and the error associated with measurement of the particular quantity (e.g., the limitations of the measurement system). For example, “about” may refer to as being within one or more standard deviations, or within ±30%, ±20%, ±10%, or ±5% of the stated value.

If (e.g., when) one or more embodiments may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, for example, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in the present disclosure is intended to include all higher numerical limitations subsumed therein. Accordingly, Applicant reserves the right to amend this specification, including the appended claims, to expressly recite any sub-range subsumed within the ranges expressly recited herein. All such ranges are intended to be inherently described in the present disclosure such that amending to expressly recite any such subranges may comply with the requirements of 35 U.S.C. § 112(a) and 35 U.S.C. § 132(a).

The electronic or electric devices and/or any other relevant devices or components (e.g., the mother substrate, the display device, the electronic device, the electronic apparatus, a device for manufacturing substantially the same, and/or the like) according to one or more embodiments of the present disclosure described herein may be implemented by utilizing any suitable hardware, firmware (e.g., an application-specific integrated circuit), software, and/or a (e.g., any suitable) combination of software, firmware, and/or hardware. For example, the one or more suitable components of these devices may be formed or provided on one integrated circuit (IC) chip and/or on separate IC chips. Further, the one or more suitable components of these devices may be implemented on a flexible printed circuit film, a tape carrier package (TCP), and/or a printed circuit board (PCB), and/or formed or provided on one substrate.

Further, the one or more suitable components of these devices may be a process or thread, running on one or more processors, in one or more computing devices, executing computer program instructions and interacting with other system components to perform the one or more suitable functionalities described herein. The computer program instructions are stored in a memory which may be implemented in a computing device by using a standard memory device, such as, for example, a random access memory (RAM). The computer program instructions may also be stored in other non-transitory computer readable media such as, for example, a CD-ROM, a flash drive, and/or the like. Also, a person of skill in the art should recognize that the functionality of one or more suitable computing devices may be combined or integrated into a single computing device, or the functionality of a particular computing device may be distributed across one or more other computing devices without departing from the spirit and scope of the present disclosure.

Unless otherwise defined, all terms (including technical and scientific terms) used herein have substantially the same meaning as generally understood by one of ordinary skill in the art to which the present disclosure belongs. It will be further understood that terms, such as those defined in dictionaries that are generally available, should be interpreted as having a meaning for example consistent with their meaning in the context of the relevant art and/or the present disclosure, and should not be interpreted in an idealized or overly formal sense, unless expressly so defined herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, embodiments of the present disclosure will be described in detail with reference to the accompanying drawings.

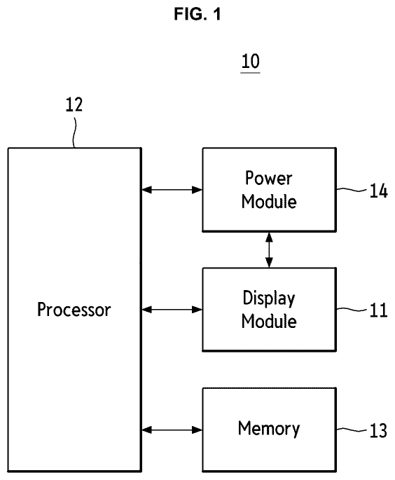

FIG. 1 is a block diagram of an electronic device according to one or more embodiments of the present disclosure.

Referring to FIG. 1, an electronic device 10 according to one or more embodiments of the present disclosure may include a display module 11, a processor 12, a memory 13, and a power module 14.

The processor 12 may include at least one of: a central processing unit (CPU), an application processor (AP), a graphic processing unit (GPU), a communication processor (CP), an image signal processor (ISP), or a controller.

The memory 13 may store data information required for the operation of the processor 12 and/or the display module 11. When the processor 12 executes an application stored in the memory 13, an image data signal and/or an input control signal may be transmitted to the display module 11. The display module 11 may process the received signal and output image information through a display screen.

The power module 14 may include a power supply module such as a power adapter and a battery device, and a power conversion module that converts the power supplied by the power supply module to generate power required for the operation of the electronic device 10.

At least one of the elements of the electronic device 10 described above may be included in the display devices according to the embodiment described above. In one or more embodiments, some of the individual modules functioning as a single module may be included in the display device while some others may be provided separately from the display device. For example, the display device may include the display module 11, and the processor 12, the memory 13, and the power module 14 may be implemented as other devices inside the electronic device 10 instead of the display device.

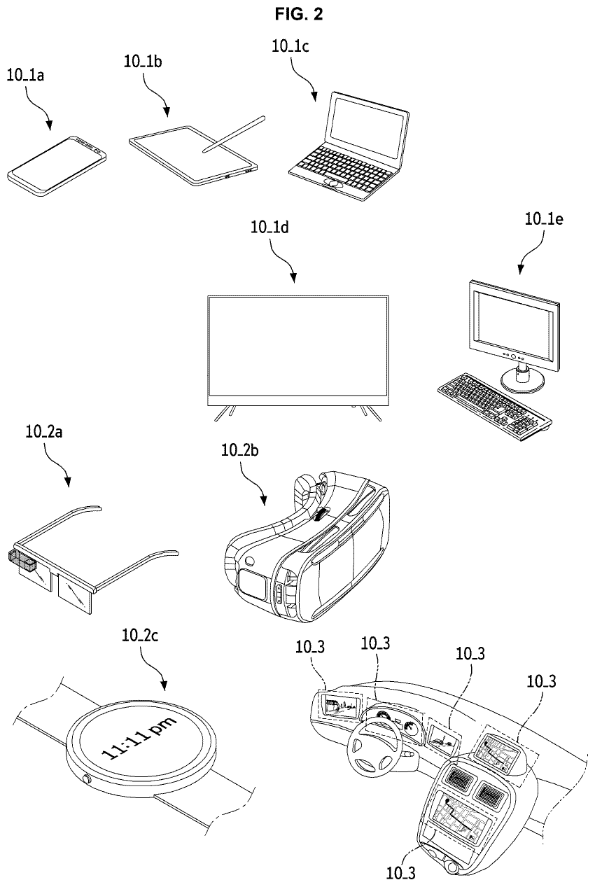

FIG. 2 is a view showing examples of electronic devices according to one or more embodiments of the present disclosure.

Referring to FIG. 2, a variety of electronic devices employing display devices according to one or more embodiments may include not only image display electronic devices such as a smart phone 10_1a, a tablet PC 10_1b, a laptop computer 10_1c, a TV 10_1d, and a desktop monitor 10_1e, but also wearable electronic devices including display modules such as smart glasses 10_2a, a head-mounted display 10_2b, and a smart watch 10_2c, and electronic devices for vehicles 10_3 including display modules such as a center information display (CID) placed on the dashboard, the center fascia and the dashboard of a vehicle, and a room mirror display.

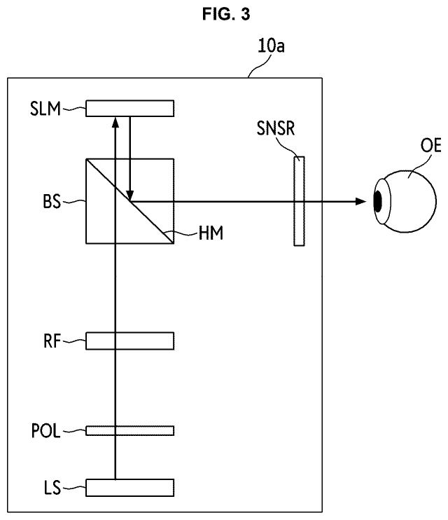

FIG. 3 is a view showing an example of an optical device according to one or more embodiments of the present disclosure.

Referring to FIG. 3, a first optical device 10a according to one or more embodiments of the present disclosure may include a light source LS, a polarization member POL, a refraction member RF, a beam splitter BS, a spatial light modulator SLM, and a sensor SNSR.

The light source LS may be a device that outputs light. The light source LS may output incoherent light. The incoherent light may refer to light whose wavelengths are not in phase.

The light source LS may include a micro-display. For example, the light source LS may be an Organic Light-Emitting Diode on Silicon (OLEDoS) display device that includes an organic light-emitting layer located on a first semiconductor substrate. As another example, the light source LS may be a Light-Emitting Diode on Silicon (LEDoS) display device that includes an inorganic light-emitting layer located on a second semiconductor substrate.

The light source LS may include a plurality of first pixels emitting light. The plurality of first pixels may be the minimum units that display white light. For example, each of the plurality of first pixels may include a first sub-pixel that displays light of a first color, a second sub-pixel that displays light of a second color, and a third sub-pixel that displays light of a third color.

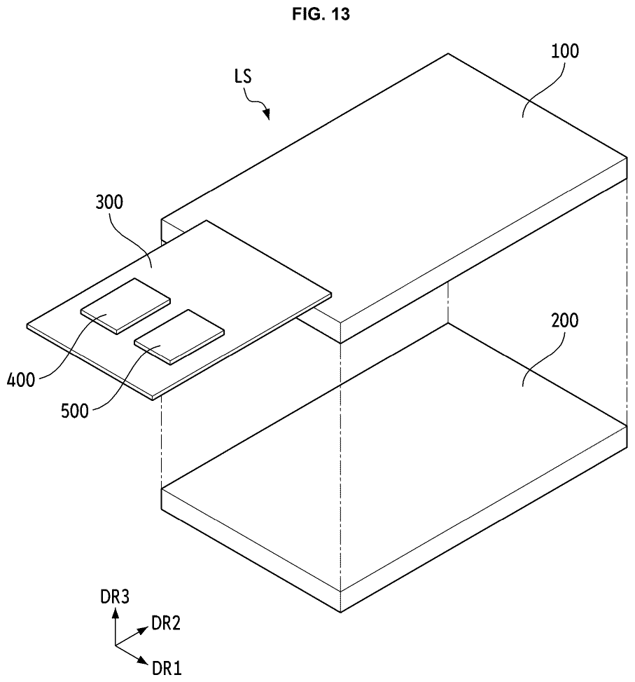

The light source LS will be described in detail later with reference to FIGS. 13-20.

The light output from the light source LS may travel to the polarization member POL. The polarization member POL may control the polarization of the light output from the light source LS. The polarization member POL may polarize the light output from the light source LS so that the light is phase-locked. For example, the polarization member POL may include a linear polarizer.

Light passing through the polarization member POL may travel to the refraction member RF. The refraction member RF may be a device that refracts light. The refraction member RF may refract light passing through the polarization member POL to have a focal length (e.g., a focal length of infinity).

The light passing through the refraction member RF may travel to the beam splitter BS. The beam splitter BS may be a device that transmits or reflects a part of incident light depending on conditions. The beam splitter BS may include a half mirror HM that transmits light incident in a direction and reflects light incident in another direction.

The beam splitter BS may transmit light that has passed through the refraction member RF. Subsequently, the beam splitter BS may reflect the light reflected off the spatial light modulator SLM. The half mirror HM of the beam splitter BS may have an angle (e.g., 45°) with respect to a light path. Accordingly, the direction of the traveling light may be changed after it is reflected off the beam splitter BS. In the example shown in FIG. 3, the half mirror HM is oriented at the angle of 45° with respect to the light path, so that the light is reflected off the beam splitter BS and the light path is bent by 90°. It should be understood, however, that the present disclosure is not limited thereto. The orientation of the half mirror HM and the changed light path may vary as desired.

Light passing through the beam splitter BS may travel to the spatial light modulator SLM. The spatial light modulator SLM may be a device that modulates the phase of incident light. The spatial light modulator SLM may include a plurality of second pixels. The plurality of second pixels may display a light modulation pattern for modulating the phase of light incident on the spatial light modulator SLM. The second pixels may be associated with the first pixels of the light source LS, respectively. For example, the spatial light modulator SLM may be a liquid crystal on silicon (LCoS) display device that includes a liquid-crystal layer located on a third semiconductor substrate.

The spatial light modulator SLM may modulate the amplitude and/or phase of light. The spatial light modulator SLM may include a reflective one that reflects incident light and a transmissive one that transmits incident light. Herein, a reflective spatial light modulator SLM will be described as an example, which modulates the phase of light, for convenience of illustration. It should be understood, however, that the present disclosure is not limited thereto. In a modified embodiment, a spatial light modulator SLM may modulate the amplitude of light.

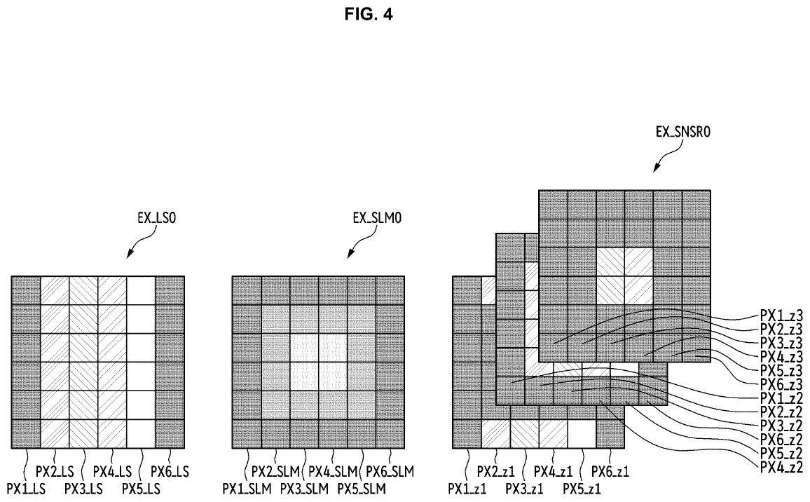

The light modulation pattern displayed by the spatial light modulator SLM will be described later with reference to FIG. 4.

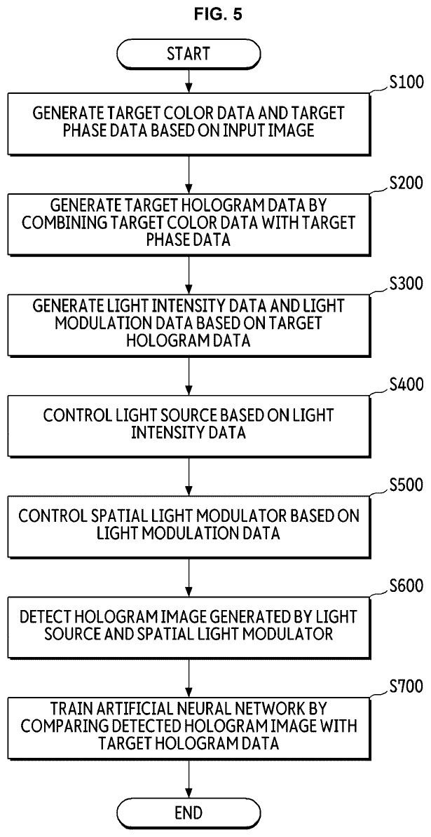

The light reflected off the beam splitter BS may travel to the sensor SNSR. The sensor SNSR may detect the incident light. The light detected by the sensor SNSR may be a holographic image having intensity and phase. The sensor SNSR may detect a holographic image provided to a user OE. The holographic image may be used to train a controller that controls the light source LS and the spatial light modulator SLM later. The operation of the controller will be described later with reference to FIGS. 5-11.

FIG. 4 is a view for illustrating the light source, the spatial light modulator, and the sensor of FIG. 3.

Referring to FIG. 4, a light source EX_LS0 may display an image. Although the light source EX_LS0 is in a square shape when viewed from the top and has pixels arranged in a 6-by-6 array in the drawings, the present disclosure is not limited thereto. The shape of the light source LS may be modified to be a circle, a polygon, a convex polygon, etc., when viewed from the top, and the array of the pixels may also be modified accordingly.

The light source EX_LS0 may include a first light source pixel PX1_LS to a sixth light source pixel PX6_LS. The first light source pixel PX1_LS to the sixth light source pixel PX6_LS may be the first pixels arranged in the last row from among the plurality of first pixels.

For example, the first light source pixel PX1_LS may not emit light, while the second light source pixel PX2_LS may emit red light. The third light source pixel PX3_LS may emit green light, and the fourth light source pixel PX4_LS may emit blue light. The fifth light source pixel PX5_LS may emit white light, and the sixth light source pixel PX6_LS may not emit light. Although some of the first pixels of the light source EX_LS0 (e.g., the second light source pixel PX2_LS, the third light source pixel PX3_LS, the fourth light source pixel PX4_LS, and the fifth light source pixel PX5_LS) emits one of red, green, blue, or white light in the example shown in FIG. 4, the present disclosure is not limited thereto. In one or more embodiments, each of the first pixels may include a first sub-pixel emitting light of a first color, a second sub-pixel emitting light of a second color different from the first color, and a third sub-pixel emitting light of a third color different from the first and second colors. In one or more embodiments, each of the first pixels may emit light of various colors by controlling the intensities of the first sub-pixel, the second sub-pixel, and the third sub-pixel.

The spatial light modulator EX_SLM0 may display a light modulation pattern. Although the spatial light modulator EX_SLM0 is in a square shape when viewed from the top and has pixels arranged in a 6 -by-6 array in the drawings, the present disclosure is not limited thereto. The shape of the spatial light modulator SLM may be modified so that it conforms to the shape of the light source LS. The array of the second pixels of the spatial light modulator SLM may also correspond to the array of the first pixels of the light source LS.

The spatial light modulator EX_SLM0 may include first to sixth phase pixels PX1_SLM to PX6_SLM. The first to sixth phase pixels PX1_SLM to PX6_SLM may be second pixels arranged in the last row from among a plurality of second pixels. The first to sixth phase pixels PX1_SLM to PX6_SLM may be associated with the first to sixth light source pixels PX1_LS to PX6_LS, respectively.

For example, the spatial light modulator EX_SLM0 may display a light modulation pattern in which the center portion has a third phase value, the edge portion has a first phase value, and a portion between the center portion and the edge portion has a second phase value between the first phase value and the third phase value. The first to third phase values may be values for 3D information (or retardation values) of a holographic image provided to a user. It should be understood, however, that the present disclosure is not limited to the first to third phase values. The spatial light modulator SLM may display a light modulation pattern having more phase values or having a different shape. For example, the first to sixth phase pixels PX1_SLM to PX6_SLM may emit light corresponding to the first phase value.

In the above example, the light modulation pattern was divided into three regions: the center portion, the edge portion, and the portion between the center portion and the edge portion. It should be understood, however, that the present disclosure is not limited thereto. The light modulation pattern of the spatial light modulator SLM may be further divided into four or more regions.

As another example, the spatial light modulator SLM may have m-by-n phase pixels, and each of the phase pixels may have an independent phase value, where m and n are natural numbers. In this instance, the light modulation pattern may be formed asymmetrically with respect to the center of the spatial light modulator SLM.

The sensor SNSR may detect a holographic image EX_SNSR0. The holographic image EX_SNSR0 may include light intensity and phase for each pixel. The holographic image EX_SNSR0 may be generated by combining the image displayed by the light source EX_LS0 with the light modulation pattern displayed by the spatial light modulator EX_SLM0.

For example, the holographic image EX_SNSR0 may include a first phase image, a second phase image, and a third phase image according to the phase value of the light modulation pattern output by the spatial light modulator EX_SLM0. The first phase image may be an image having the first phase value, the second phase image may be an image having the second phase value, and the third phase image may be an image having the third phase value.

The first phase image may include first to sixth hologram pixels PX1_z1 to PX6_z1. The first to sixth hologram pixels PX1_z1 to PX6_z1 may be pixels arranged in the last row from among the pixels included in the first phase image.

Because the first phase pixel PX1_SLM has the first phase value, the first hologram pixel PX1_z1 may have the light intensity of the first light source pixel PX1_LS. Because the first light source pixel PX1_LS does not emit light, the color of the first hologram pixel PX1_z1 may be black.

Because the second phase pixel PX2_SLM has the first phase value, the second hologram pixel PX2_z1 may have the light intensity of the second light source pixel PX2_LS. Because the second light source pixel PX2_LS emits red light, the color of the second hologram pixel PX2_z1 may be red.

Because the third phase pixel PX3_SLM has the first phase value, the third hologram pixel PX3_z1 may have the light intensity of the third light source pixel PX3_LS. Because the third light source pixel PX3_LS emits green light, the color of the third hologram pixel PX3_z1 may be green.

Because the fourth phase pixel PX4_SLM has the first phase value, the fourth hologram pixel PX4_z1 may have the light intensity of the fourth light source pixel PX4_LS. Because the fourth light source pixel PX4_LS emits blue light, the color of the fourth hologram pixel PX4_z1 may be blue.

Because the fifth phase pixel PX5_SLM has the first phase value, the fifth hologram pixel PX5_z1 may have the light intensity of the fifth light source pixel PX5_LS. Because the fifth light source pixel PX5_LS emits white light, the color of the fifth hologram pixel PX5_z1 may be white.

Because the sixth phase pixel PX6_SLM has the first phase value, the sixth hologram pixel PX6_z1 may have the light intensity of the sixth light source pixel PX6_LS. Because the sixth light source pixel PX6_LS does not emit light, the color of the sixth hologram pixel PX6_z1 may be black.

The second phase image may include seventh to twelfth hologram pixels PX1_z2 to PX6_z2. The seventh to twelfth hologram pixels PX1_z2 to PX6_z2 may be pixels arranged in the last row from among the pixels included in the second phase image.

Because the first phase pixel PX1_SLM has the first phase value, the light intensity of the seventh hologram pixel PX1_z2 may be zero. That is to say, the color of the seventh hologram pixel PX1_z2 may be black.

Likewise, Because the second to sixth phase pixels PX2_SLM to PX6_SLM have the first phase value, the light intensity of the eighth to twelfth hologram pixels PX2_z2 to PX6_z2 may be zero. That is to say, the color of the eighth to twelfth hologram pixels PX2_z2 to PX6_z2 may be black.

The third phase image may include thirteenth to eighteenth hologram pixels PX1_z3 to PX6_z3. The thirteenth to eighteenth hologram pixels PX1_z3 to PX6_z3 may be pixels arranged in the last row from among the pixels included in the third phase image.

Because the first to sixth phase pixels PX1_SLM to PX6_SLM have the first phase value, the light intensity of the thirteenth to eighteenth hologram pixels PX1_z3 to PX6_z3 may be zero. That is to say, the color of the thirteenth to eighteenth hologram pixels PX1_z3 to PX6_z3 may be black.

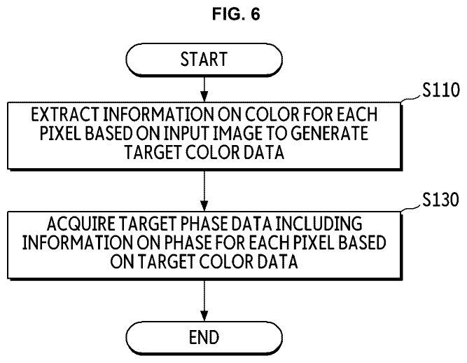

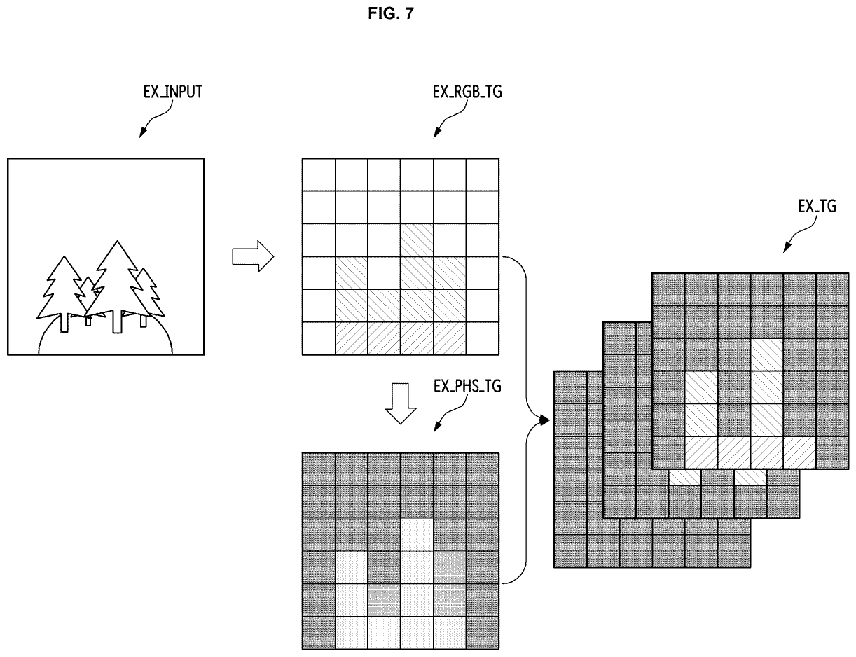

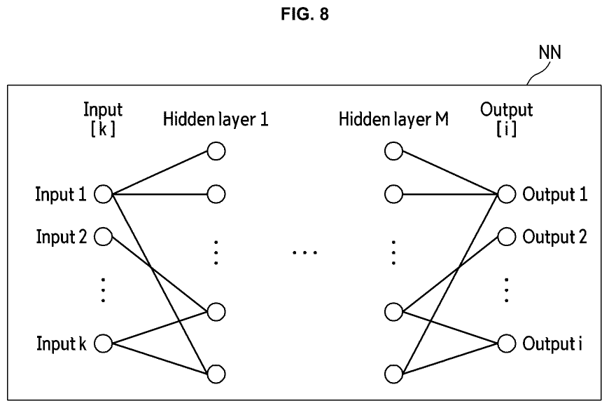

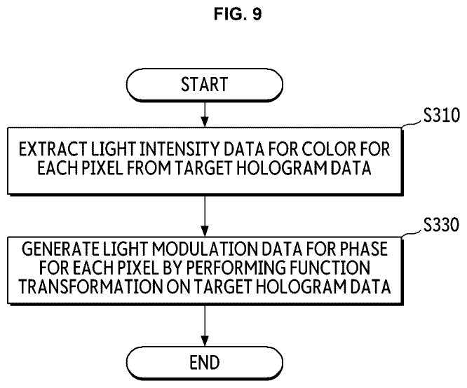

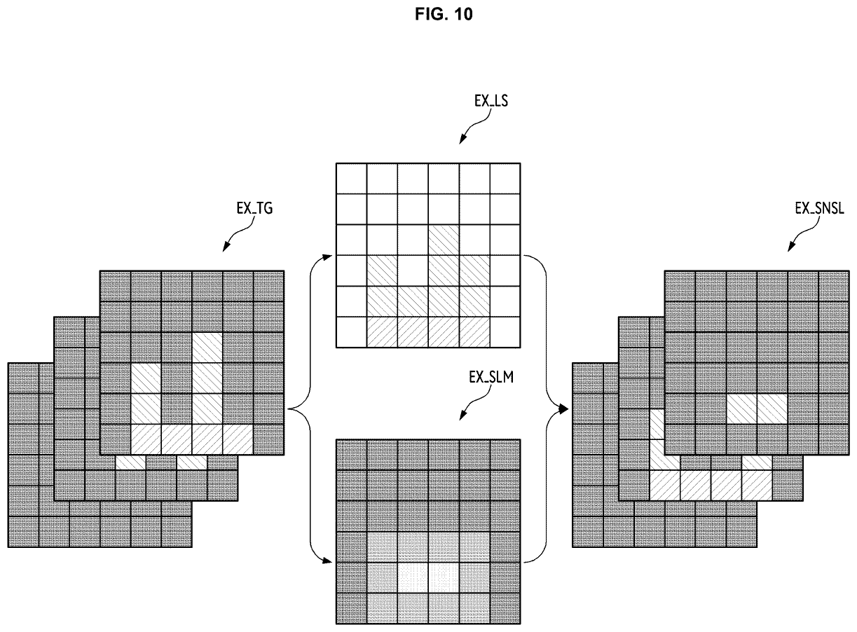

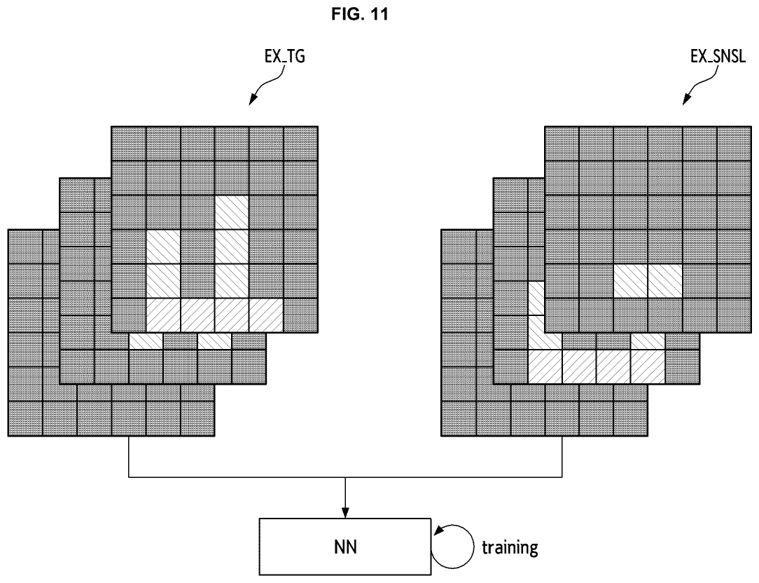

FIG. 5 is a flowchart for illustrating a method for operating an electronic device according to one or more embodiments of the present disclosure. FIG. 6 is a flowchart for illustrating a step S100 of FIG. 5 in detail. FIG. 7 is a view for illustrating target color data and target phase data of FIG. 6. FIG. 8 is a view for illustrating an artificial neural network of a controller of an optical device according to one or more embodiments of the present disclosure. FIG. 9 is a flowchart for illustrating a step S300 of FIG. 5 in detail. FIG. 10 is a view for illustrating the light intensity data and light modulation pattern of FIG. 9. FIG. 11 is a view for illustrating training of the artificial neural network of FIG. 8.

Each step described below may be performed by the processor 12 of the electronic device 1. The processor 12 may execute a control application for controlling the light source LS and the spatial light modulator SLM from among the applications stored in the memory 13. For convenience of illustration, the subject of the operation of controlling the light source LS and the spatial light modulator SLM by executing the control application by the processor 12 will be referred to as a controller. In other words, the controller may be a part of the processor 12.

Initially, the controller generates target color data and target phase data based on an input image (step S100 of FIG. 5).

The controller may receive an input image from an external source and/or may utilize an image stored in the electronic device 10 as the input image. The input image is a 2D image and may include information on the intensity of light. The input image may not include information on the phase.

Specifically, the controller may generate the target color data by extracting information on the color for each pixel based on the input image (step S110 of FIG. 6).

Referring to FIG. 7, the controller may divide an input image EX_INPUT into sections and may extract the color for each of the sections. For example, the controller may extract the color for each of the sections using a method well known in the art, such as clustering and/or foreground extraction.

At this time, the size and number of the sections (i.e., the number of pixels) of the input image EX_INPUT may vary depending on at least one of the image quality of the input image EX_INPUT, the number of the first pixels of the light source LS, or the number of the second pixels of the spatial light modulator SLM.

The controller may extract information on the color for each pixel of the input image EX_INPUT to generate target color data EX_RGB_TG. That is to say, the target color data EX_RGB_TG may include information on the amplitude of the hologram that the first optical device 10a is to display.

Subsequently, the controller may acquire target phase data containing the information on the phase for each pixel based on the target color data (step S130 of FIG. 6).

The controller may include an artificial neural network (ANN). The artificial neural network may receive the target color data EX_RGB_TG as input and may generate target phase data EX_PHS_TG as output of the artificial neural network.

The target phase data EX_PHS_TG may include the information on the phase for each pixel. Accordingly, the target phase data EX_PHS_TG may include information on the phase of the hologram that the first optical device 10a is to display, i.e., 3D information.

For example, the artificial neural network may utilize a variety of deep learning architectures well known in the art. Deep learning technology is to learn down to a deep-level of multi-levels based on data. For example, the artificial neural network may have HoloNet architecture including a convolutional neural network (CNN).

The CNN is a type of artificial neural networks used to analyze visual images. The CNN may include a convolutional layer, a pooling layer, and a fully connected layer.

The convolution layer may extract features by searching the input image with a filter, and may create a feature map through this.

The pooling layer is an operation that reduces the space of the data by extracting representative values from among pixels within a range. There may be max pooling which extracts the maximum value of the pixels within a range as a representative value, and average pooling which extracts the average value of pixels within a range as a representative value.

The fully connected layer is mainly used to classify images, and refers to a scenario where all nodes of each layer being connected to all nodes of the next layer.

HoloNet may use the Concatenated Rectified Linear Unit (CReLu) function as an activation function.

The training of the artificial neural network may include updating the weight and the bias of the connection lines between nodes so that the desired output is generated for a given input. In one or more embodiments, an algorithm such as backpropagation may be used for the training the artificial neural network.

Artificial neural networks may be trained through either supervised learning where correct data is labeled, or unsupervised learning where correct data is not labeled.

Referring to FIG. 8, an artificial neural network NN includes an input layer Input with target color data as input nodes, an output layer Output with the extracted target phase data as output nodes, and M hidden layers arranged between the input layer Input and the output layer Output.

Weights may be set for the edges connecting between the nodes of each layer. Whether there is an edge connecting between the nodes and whether there is a weight for each edge may be updated during the training process. Therefore, the weights for the nodes and the edges arranged between the k input nodes and the i output nodes may be updated.

All of the nodes and the edges may be initialized before training the artificial neural network NN. As the training is performed, the weights for the nodes and the edges may be updated. During this process, the parameters input to the input nodes and the values assigned to the output nodes may be matched.

Subsequently, the controller combines the target color data with the target phase data to generate the target hologram data (step S200 of FIG. 5).

Referring to FIG. 7, the target hologram data EX_TG may include the information on the color for each pixel and the information on the phase for each pixel. For example, when the target phase data EX_PHS_TG has a light modulation pattern having three phase values, the target hologram data EX_TG may have three phase images.

Subsequently, the controller generates light intensity data and light modulation pattern based on the target hologram data (step S300 of FIG. 5).

Specifically, the controller may extract the light intensity data including the color for each pixel from the target hologram data (step S310 of FIG. 9).

Referring to FIG. 10, the controller may extract light intensity data EX_LS from the target hologram data EX_TG. The light intensity data EX_LS may include the intensity of light emitted by each of the first pixels of the light source LS (i.e., the intensity of light emitted by each of the first to third sub-pixels and the color of each of the first pixels resulting therefrom).

Subsequently, the controller may convert the target hologram data to generate light modulation data for the phase for each pixel (step S330 of FIG. 9).

Referring to FIG. 10, the controller may generate light modulation data EX_SLM from the target hologram data EX_TG. The controller performs a function transformation on the target hologram data EX_TG and may generate light modulation data EX_SLM for the phase for each pixel based on this. The light modulation data EX_SLM may include a light modulation pattern displayed by a plurality of second pixels of the spatial light modulator SLM to modulate the phase of light.

For example, the controller may perform a function transformation on the target hologram data EX_TG using Zernike polynomials. As another example, the controller may perform a function transformation on the target hologram data EX_TG using a Fourier transform. As described above, the present disclosure is not limited to a particular function transformation, and any of a variety of function transformation methods well known in the art may be used.

Subsequently, the controller controls the light source based on the light intensity data (step S400 of FIG. 5).

The light source LS receives the light intensity data EX_LS and may allow the first pixels to emit light based on the light intensity data.

Subsequently, the controller controls the spatial light modulator based on the light modulation data (step S500 of FIG. 5).

The spatial light modulator SLM may receive the light modulation data EX_SLM and operate a plurality of second pixels based on it.

Subsequently, the sensor detects a holographic image generated by the light source and the spatial light modulator (step S600 in FIG. 5).

Referring to FIG. 10, the sensor SNSR may detect a holographic image EX_SNSL generated by the light source LS and the spatial light modulator SLM. The holographic image EX_SNSL may include information on the amplitude of an object displayed by the first optical device 10a and information on the phase of the object.

Subsequently, the controller compares the detected hologram image with the target hologram data to train the artificial neural network (step S700 in FIG. 5).

Referring to FIG. 11, the artificial neural network NN may receive the target hologram data EX_TG and the hologram image EX_SNSL as inputs. The artificial neural network NN may perform supervised training by setting the target hologram data EX_TG as the correct data. Specifically, the artificial neural network NN may calculate a loss between the target hologram data EX_TG and the hologram image EX_SNSL and may update the weights and biases inside the artificial neural network NN to reduce the loss. In order to calculate the loss, loss functions well known in the art may be used, such as the mean squared error (MSE) and/or the cross-entropy.

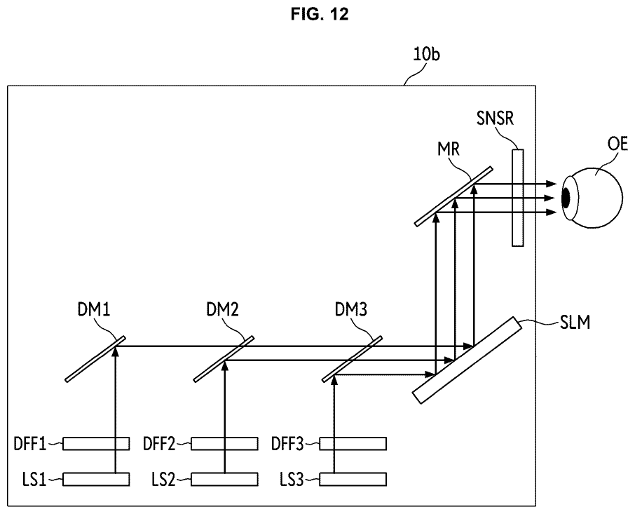

FIG. 12 is a view showing an example of an optical device according to one or more embodiments of the present disclosure. The following description will focus on differences and the redundant description will be omitted.

Referring to FIG. 12, a second optical device 10b according to one or more embodiments of the present disclosure may include a first light source LS1, a second light source LS2, a third light source LS3, a first refraction member DFF1, a second refraction member DFF2, a third refraction member DFF3, a first reflection member DM1, a second reflection member DM2, a third reflection member DM3, a fourth reflection member MR, a spatial light modulator SLM, and a sensor SNSR.

The first light source LS1 may include a plurality of third pixels for emitting light of a first color. The first light source LS1 may include a micro display. For example, the first light source LS1 may be a display device including a micro display that includes only a plurality of third pixels for emitting red light.

The second light source LS2 may include a plurality of fourth pixels for emitting light of a second color. The second light source LS2 may include a micro display. For example, the second light source LS2 may be a display device including a micro display that includes only a plurality of fourth pixels for emitting green light. In one or more embodiments, the plurality of fourth pixels may be associated with the plurality of third pixels, respectively.

The third light source LS3 may include a plurality of fifth pixels for emitting light of a third color. The third light source LS3 may include a micro display. For example, the third light source LS3 may be a display device including a micro display that includes only a plurality of fifth pixels for emitting blue light. In one or more embodiments, the plurality of fifth pixels may be associated with the plurality of third pixels and with the plurality of fourth pixels, respectively.

The first refraction member DFF1 may be located on one side of the first light source LS1. The first refraction member DFF1 may be arranged parallel to the first light source LS1. The first refraction member DFF1 may collimate light of the first color emitted from the first light source LS1. Collimation refers to making light parallel. For example, the first refraction member DFF1 may include a convex lens.

The second refraction member DFF2 may be located on one side of the second light source LS2. The second refraction member DFF2 may be arranged parallel to the second light source LS2. The second refraction member DFF2 may collimate light of the second color emitted from the second light source LS2. For example, the second refraction member DFF2 may include a convex lens.

The third refraction member DFF3 may be located on one side of the third light source LS3. The third refraction member DFF3 may be arranged parallel to the third light source LS3. The third refraction member DFF3 may collimate light of the third color emitted from the third light source LS3. For example, the third refraction member DFF3 may include a convex lens.

The first reflection member DM1 may be located on one side of the first refraction member DFF1. The first reflection member DM1 may be oriented in such a direction that crosses the orientation direction of the first refraction member DFF1. The first reflection member DM1 may reflect light in a first wavelength range and transmit light in other wavelength ranges than the first wavelength range. For example, the first reflection member DM1 may include a dichroic mirror that reflects light of a first color (e.g., red) and transmits light of other colors than the first color.

The second reflection member DM2 may be located on one side of the second refraction member DFF2. The second reflection member DM2 may be oriented in such a direction that crosses the orientation direction of the second refraction member DFF2. The second reflection member DM2 may reflect light in a second wavelength range and transmit light in other wavelength ranges than the second wavelength range. For example, the second reflection member DM2 may include a dichroic mirror that reflects light of a second color (e.g., green) and transmits light of other colors than the second color.

The third reflection member DM3 may be located on one side of the third refraction member DFF3. The third reflection member DM3 may be oriented in such a direction that crosses the orientation direction of the third refraction member DFF3. The third reflection member DM3 may reflect light in a third wavelength range and transmit light in other wavelength ranges than the third wavelength range. For example, the third reflection member DM3 may include a dichroic mirror that reflects light of a third color (e.g., blue) and transmits light of other colors than the third color.

The spatial light modulator SLM may be placed on one side of the third reflection member DM3. For example, the first reflection member DM1, the second reflection member DM2, the third reflection member DM3, and the spatial light modulator SLM may be arranged parallel to each other in a row.

The spatial light modulator SLM may be a device that modulates the phases of light of the first color incident from the first reflection member DM1, light of the second color incident from the second reflection member DM2, and light of the third color incident from the third reflection member DM3. The spatial light modulator SLM may include a plurality of second pixels for displaying a light modulation pattern. The second pixels may be associated with a plurality of third pixels of the first light source LS1, with a plurality of fourth pixels of the second light source LS2, and with a plurality of fifth pixels of the third light source LS3, respectively.

The fourth reflection member MR may be arranged on one side of the spatial light modulator SLM. The fourth reflection member MR may reflect the light of the first color whose phase is modulated, the light of the second color whose phase is modulated, and the light of the third color whose phase is modulated from the spatial light modulator SLM and may provide them to the user OE. The fourth reflection member MR may be eliminated depending on the design of the second optical device 10b.

The sensor SNSR may detect the incident light. The light detected by the sensor SNSR may be a holographic image having intensity and phase.

The spatial light modulator SLM and the sensor SNSR may be substantially identical to those described above in FIG. 3; and, therefore, the redundant descriptions will be omitted.

In one or more embodiments, the second optical device 10b may include a controller. The controller of the second optical device 10b may be substantially identical to the controller of the first optical device 10a described above with reference to FIGS. 4-11.

Briefly, the controller may control the first light source LS1, the second light source LS2, the third light source LS3 and the spatial light modulator SLM based on the input image.

The controller may generate the target color data EX_RGB_TG (see FIG. 7) and the target phase data EX_PHS_TG (see FIG. 7) based on the input image EX_INPUT (see FIG. 7) received from an external source or stored in advance. The target color data may include information on the color for each pixel of the input image. The target phase data may include information on the phase for each pixel of the input image. The target phase data may be obtained by inputting the target color data into the trained artificial neural network and outputting it.

The controller may generate the target hologram data EX_TG (see FIG. 7) by combining the target color data with target phase data. The target hologram data may include information on the color for each pixel and information on the phase for each pixel.

The controller may generate light intensity data EX_LS and light modulation data EX_SLM based on the target hologram data EX_TG.

The controller may extract the light intensity data EX_LS including the color for each pixel from the target hologram data. The controller may perform function transformation on the target hologram data and may generate the light modulation data EX_SLM for the phase for each pixel.

The controller may control the first to third light sources LS1 to LS3 by transmitting the light intensity data EX_LS to the first to third light sources LS1 to LS3, and may control the spatial light modulator SLM by transmitting the light modulation data EX_SLM to the spatial light modulator SLM.

Specifically, the controller may determine the intensity of light emitted from each of the third pixels of the first light source LS1, the fourth pixels of the second light source LS2, and the fifth pixels of the third light source LS3, according to the light intensity data EX_LS.

For example, if the color of the first position of the light intensity data is the first color, the controller may determine the intensity of light emitted by the third pixel corresponding to the first position from among the plurality of third pixels as the first intensity, the intensity of light emitted by the fourth pixel corresponding to the first position from among the plurality of fourth pixels as zero, and the intensity of light emitted by the fifth pixel corresponding to the first position from among the plurality of fifth pixels as zero.

If the color of the second position of the light intensity data is a fourth color that is a mixture of the second color and the third color, the controller may determine the intensity of light emitted by the third pixel corresponding to the second position from among the plurality of third pixels as zero, the intensity of light emitted by the fourth pixel corresponding to the second position from among the plurality of fourth pixels as the second intensity, and the intensity of light emitted by the fifth pixel corresponding to the second position from among the plurality of fifth pixels as the third intensity.

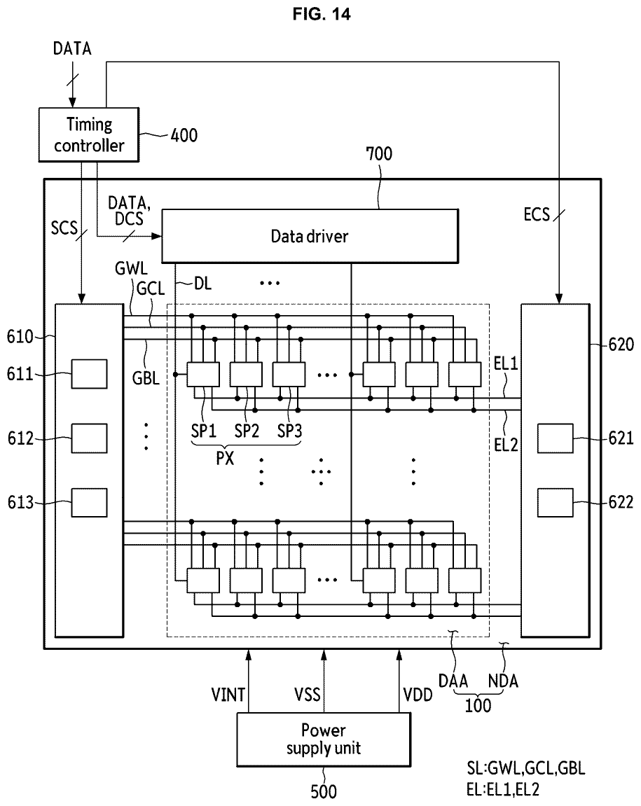

FIG. 13 is an exploded, perspective view of a light source (e.g., a display device) according to one or more embodiments of the present disclosure. FIG. 14 is a view showing a layout of the display panel of FIG. 13.

Referring to FIGS. 13 and 14, the light source LS (e.g., a display device) according to one or more embodiments displays moving images and/or still images. The light source LS according to the embodiment may be employed by portable electronic devices such as a mobile phone, a smart phone, a tablet PC, a mobile communications terminal, an electronic notebook, an electronic book, a portable multimedia player (PMP), a navigation device, and/or a ultra mobile PC (UMPC). For example, the light source LS according to the embodiment of the disclosure may be used as a display unit of a television, a laptop computer, a monitor, an electronic billboard, and/or the Internet of Things (IOT). Alternatively, the light source LS according to the embodiment of the present disclosure may be applied to a smart watch, a watch phone, and/or a head-mounted display (HMD) for implementing virtual reality and/or augmented reality.

According to the embodiment, the light source LS includes a display panel 100, a heat dissipation layer 200, a circuit board 300, a timing control circuit (e.g., a timing controller) 400, and a power supply circuit (e.g., a power supply unit) 500.

The display panel 100 may have a shape similarly to a rectangular shape when viewed from the top. For example, the display panel 100 may have a shape similar to a rectangle having shorter sides in the first direction DR1 and longer sides in the second direction DR2 intersecting the first direction DR1 when viewed from the top. In the display panel 100, the corners where the shorter sides in the first direction DR1 meet the longer sides in the second direction DR2 may be rounded with a suitable curvature (e.g., a predetermined curvature) or may be a right angle. The shape of the display panel 100 when viewed from the top is not limited to a rectangular shape, but may be formed in a shape similar to other polygonal shapes, a circular shape, or an elliptical shape. The shape of the light source LS may follow the shape of the display panel 100 when viewed from the top, but the present disclosure is not limited thereto.

The display panel 100 includes a plurality of pixels PX, a plurality of scan lines SL, a plurality of light-emitting control lines EL, a plurality of data lines DL, a scan driver 610, a light-emitting driver 620, and a data driver 700. The display panel 100 may be divided into a display area DAA where images are displayed, and a non-display area NDA where no image is displayed as shown in FIG. 14.

The plurality of pixels PX may be arranged in the display area DAA. The pixels PX may be arranged in a matrix along the first direction DR1 and the second direction DR2. The scan lines SL and the light-emitting control lines EL may be extended in the first direction DR1 and may be arranged along the second direction DR2. The data lines DL may be extended in the second direction DR2 and may be arranged along the first direction DR1.

The plurality of scan lines SL includes a plurality of write scan lines GWL, a plurality of control scan lines GCL, and a plurality of bias scan lines GBL. The plurality of light-emitting control lines EL includes a plurality of first light-emitting control lines EL1 and a plurality of second light-emitting control lines EL2.

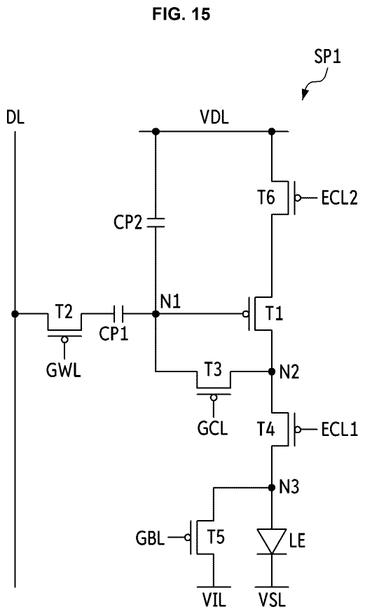

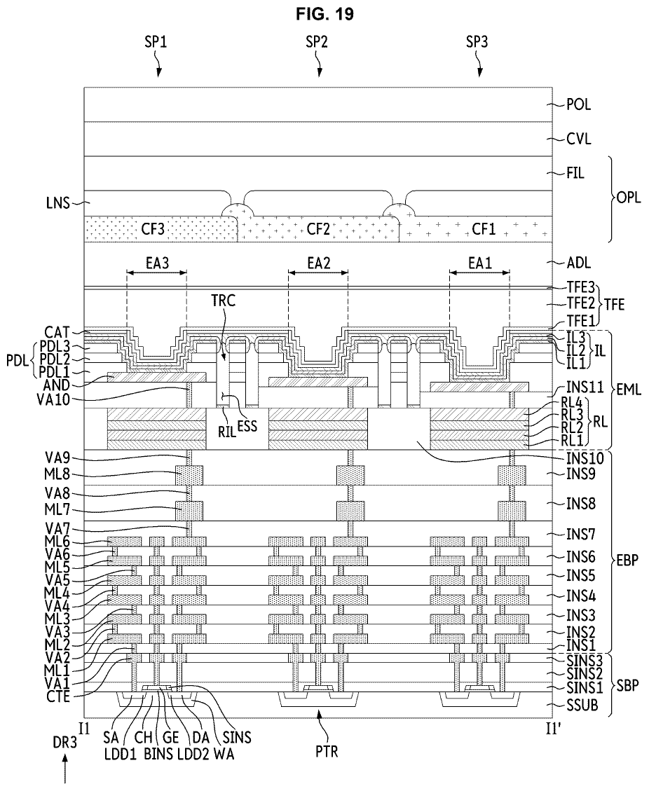

The plurality of pixels PX includes a plurality of sub-pixels SP1, SP2, and SP3. The plurality of sub-pixels SP1, SP2, and SP3 includes a plurality of pixel transistors as shown in FIG. 15. The pixel transistors are formed via a semiconductor process and may be arranged on a semiconductor substrate SSUB (see FIG. 19). For example, the pixel transistors of the data driver 700 may be implemented as complementary metal oxide semiconductor (CMOS). It should be understood, however, that the present disclosure is not limited thereto.

Each of the plurality of sub-pixels SP1, SP2, and SP3 may be connected to one write scan line GWL, one control scan line GCL, one bias scan line GBL, one first light-emitting control line EL1, one second light-emitting control line EL2, and one data line DL. Each of the sub-pixels SP1, SP2, and SP3 may receive the data voltage from the data line DL according to the write scan signal from the write scan line GWL, and may allow the light-emitting elements to emit light according to the data voltage.

The scan driver 610, the light-emitting driver 620, and the data driver 700 may be arranged in the non-display area NDA.

The scan driver 610 includes a plurality of scan transistors, and the light-emitting driver 620 includes a plurality of light-emitting transistors. A plurality of scan transistors and a plurality of light-emitting transistors are formed via a semiconductor process and may be formed on the semiconductor substrate SSUB (see FIG. 19). For example, a plurality of scan transistors and a plurality of light-emitting transistors may be formed of CMOS. It should be understood, however, that the present disclosure is not limited thereto.

The scan driver 610 may include a write scan signal output unit 611, a control scan signal output unit 612, and a bias scan signal output unit 613. Each of the write scan signal output unit 611, the control scan signal output unit 612, and the bias scan signal output unit 613 may receive a scan timing control signal SCS from the timing control circuit (e.g., the timing controller) 400. The write scan signal output unit 611 may generate write scan signals according to the scan timing control signal SCS from the timing control circuit (e.g., the timing controller) 400 and sequentially output them to the write scan lines GWL. The control scan signal output unit 612 may generate control scan signals according to the scan timing control signal SCS and sequentially output them to the control scan lines GCL. The bias scan signal output unit 613 may generate bias scan signals according to the scan timing control signal SCS and sequentially output them to the bias scan lines EBL.

The light-emitting driver 620 includes a first light-emitting control driver 621 and a second light-emitting control driver 622. Each of the first light-emitting control driver 621 and the second light-emitting control driver 622 may receive a light-emitting timing control signal ECS from the timing control circuit (e.g., the timing controller) 400. The first light-emitting control driver 621 may generate first light-emitting control signals according to the light-emitting timing control signal ECS and sequentially output them to the first light-emitting control lines EL1. The second light-emitting control driver 622 may generate second light-emitting control signals according to the light-emitting timing control signal ECS and sequentially output them to the second light-emitting control lines EL2.

The data driver 700 may include a plurality of data transistors, and the plurality of data transistors may be formed via a semiconductor process and may be formed on the semiconductor substrate SSUB (see FIG. 19). For example, a plurality of data transistors may be formed of CMOS transistors. It should be understood, however, that the present disclosure is not limited thereto.

The data driver 700 may receive digital video data DATA and a data timing control signal DCS from the timing control circuit (e.g., the timing controller) 400. The data driver 700 converts the digital video data DATA into analog data voltages according to the data timing control signal DCS and outputs them to the data lines DL. In doing so, the sub-pixels SP1, SP2, and SP3 are selected by the write scan signal of the scan driver 610, and data voltages may be applied to the selected sub-pixels SP1, SP2, and SP3.

The heat dissipation layer 200 may overlap with the display panel 100 in the third direction DR3, which is the thickness direction of the display panel 100. The heat dissipation layer 200 may be located on one surface of the display panel 100, e.g., on the rear surface. The heat dissipation layer 200 serves to release heat generated in the display panel 100. The heat dissipation layer 200 may include a metal layer such as graphite, silver (Ag), copper (Cu) and/or aluminum (Al) having a high thermal conductivity.

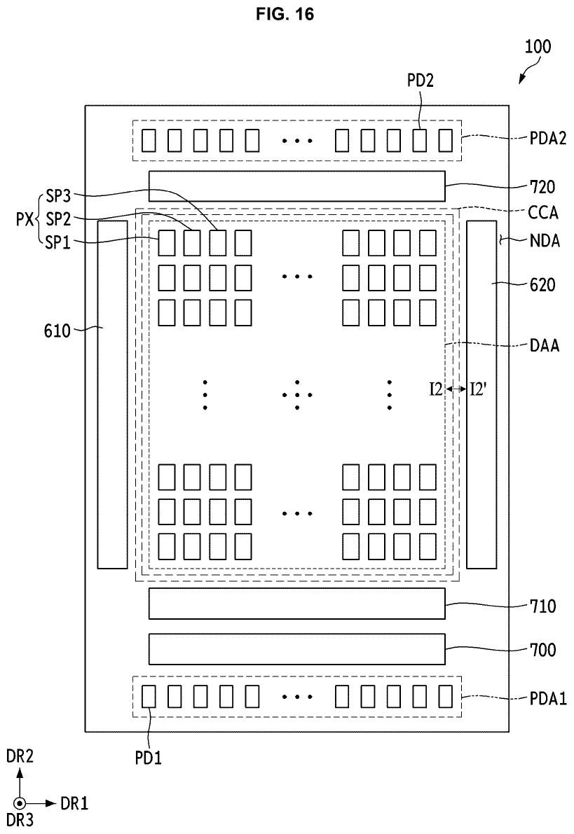

The circuit board 300 may be electrically connected to a plurality of first pads PD1 (see FIG. 16) of a first pad area PDA1 (see FIG. 16) of the display panel 100 using a conductive adhesive member such as an anisotropic conductive film. The circuit board 300 may be a flexible printed circuit board (FPCB) made of a flexible material, or a flexible film. Although the circuit board 300 is unfolded in the example shown in FIG. 13, the circuit board 300 may be bent. When the circuit board 300 is bent, one end of the circuit board 300 may be located on the rear surface of the display panel 100 and/or the rear surface of the heat dissipation layer 200. The other end of the circuit board 300 may be connected to a plurality of first pads PD1 (see FIG. 16) of the first pad area PDA1 (see FIG. 16) of the display panel 100 using a conductive adhesive material. One end of the circuit board 300 may be opposite to the other end of the circuit board 300.

The timing control circuit (e.g., the timing controller) 400 may receive digital video data and timing signals from the outside. The timing control circuit (e.g., the timing controller) 400 may generate a scan timing control signal SCS, a light-emitting timing control signal ECS, and a data timing control signal DCS for controlling the display panel 100 in response to the timing signals. The timing control circuit (e.g., the timing controller) 400 may output the scan timing control signal SCS to the scan driver 610 and output the light-emitting timing control signal ECS to the light-emitting driver 620. The timing control circuit 400 may output the digital video data DATA and the data timing control signal DCS to the data driver 700.

A power supply circuit (e.g., a power supply unit) 500 may generate a plurality of panel driving voltages in response to a supply voltage from the outside. For example, the power supply circuit (e.g., the power supply unit) 500 may generate a first supply voltage VSS, a second supply voltage VDD, and a third supply voltage VINT to apply them to the display panel 100. The first supply voltage VSS, the second supply voltage VDD, and the third supply voltage VINT will be described later with reference to FIG. 15.

Each of the timing control circuit (e.g., the timing controller) 400 and the power supply circuit (e.g., the power supply unit) 500 may be implemented as an integrated circuit (IC) and attached to a surface of the circuit board 300. The scan timing control signal SCS, the light-emitting timing control signal ECS, the digital video data DATA, and the data timing control signal DCS from the timing control circuit (e.g., the timing controller) 400 may be supplied to the display panel 100 through the circuit board 300. The first supply voltage VSS, the second supply voltage VDD, and the third supply voltage VINT of the power supply circuit (e.g., the power supply unit) 500 may be supplied to the display panel 100 through the circuit board 300.

Alternatively, each of the timing control circuit (e.g., the timing controller) 400 and the power supply circuit (e.g., the power supply unit) 500 may be located in the non-display area NDA of the display panel 100, similarly to the scan driver 610, the light-emitting driver 620, and the data driver 700. In this instance, the timing control circuit (e.g., the timing controller) 400 may include a plurality of timing transistors, and each power supply circuit (e.g., the power supply unit) 500 may include a plurality of power transistors. A plurality of timing transistors and a plurality of power transistors may be formed via a semiconductor process and may be formed on the semiconductor substrate SSUB (see FIG. 19). For example, the plurality of timing transistors and the plurality of power transistors may be formed of CMOS transistors. It should be understood, however, that the present disclosure is not limited thereto. Each of the timing control circuit (e.g., the timing controller) 400 and the power supply circuit (e.g., the power supply unit) 500 may be located between the data driver 700 and the first pad area PDA1 (see FIG. 16).

FIG. 15 is an equivalent circuit diagram of a first sub-pixel according to one or more embodiments of the present disclosure.

Referring to FIG. 15, a first sub-pixel SP1 may be connected to a write scan line GWL, a control scan line GCL, a bias scan line GBL, a first light-emitting control line EL1, a second light-emitting control line EL2, and a data line DL. In one or more embodiments, the first sub-pixel SP1 may be connected to a first supply voltage line VSL where the first supply voltage VSS equal to a low-level voltage is applied, a second supply voltage line VDL where the second supply voltage VDD equal to a high-level voltage is applied, and a third supply voltage line VIL where the third supply voltage VINT equal to an initialization voltage is applied.

The first sub-pixel SP1 includes a plurality of transistors T1 to T6, a light-emitting element LE, a first capacitor CP1, and a second capacitor CP2.

The light-emitting element LE emits light according to a driving current Ids flowing in a channel of the first transistor T1. The amount of the light emitted from the light-emitting element LE may be proportional to the driving current Ids. The first electrode of the light-emitting element LE may be an anode electrode, and the second electrode of the light-emitting element LE may be a cathode electrode. The light-emitting element LE may be an organic light-emitting diode (OLED) including a first electrode, a second electrode, and an organic light-emitting layer located between the first electrode and the second electrode. It should be understood, however, that the present disclosure is not limited thereto. For example, the light-emitting element LE may be an inorganic light-emitting element including a first electrode, a second electrode, and an inorganic semiconductor located between the first electrode and the second electrode. In this instance, the light-emitting element LE may be a micro light-emitting diode.

The first transistor T1 may be a driving transistor for controlling the source-drain current Ids (hereinafter referred to as “driving current”) flowing between the source electrode and the drain electrode according to the voltage applied to the gate electrode. The first transistor T1 may be connected between the sixth transistor T6 and a second node N2. A gate electrode of the first transistor T1 may be connected to a first node N1.

The second transistor T2 may be located between one electrode of the first capacitor CP1 and the data line DL. The second transistor T2 is turned on by a write scan signal from the write scan line GWL and connects the electrode of the first capacitor CP1 to the data line DL. Accordingly, the data voltage of the data line DL may be applied to the electrode of the first capacitor CP1.

A third transistor T3 may be located between the first node N1 and the second node N2. The third transistor T3 is turned on by the write control signal of the write control line GCL and connects the first node N1 to the second node N2. Accordingly, if the gate electrode and source electrode of the first transistor T1 are connected with each other, the first transistor T1 may act like a diode (e.g., the first transistor T1 may be diode-connected).

The fourth transistor T4 may be connected between the second node N2 and a third node N3. The fourth transistor T4 is turned on by a first light-emitting control signal of the first light-emitting control line EL1 and connects the second node N2 to the third node N3. Accordingly, the driving current Ids of the first transistor T1 may be supplied to the light-emitting element LE. The fifth transistor T5 may be located between the third node N3 and the third supply voltage line VIL. The fifth transistor T5 is turned on by a bias scan signal of the bias scan line GBL and connects the third node N3 to the third supply voltage line VIL. Accordingly, the third supply voltage VINT of the third supply voltage line VIL may be applied to the first electrode of the light-emitting element LE.

The sixth transistor T6 may be located between the drain electrode of the first transistor T1 and the second supply voltage line VDL. The sixth transistor T6 is turned on by the second light-emitting control signal of the second light-emitting control line EL2 and connects the drain electrode of the first transistor T1 to the second driving voltage line VDL. Accordingly, the second driving voltage VDD of the second driving voltage line VDL may be applied to the drain electrode of the first transistor T1.

The first capacitor CP1 is formed between the first node N1 and the source electrode of the second transistor T2. The second capacitor CP2 is formed between the gate electrode of the first transistor T1 (e.g., the first node N1) and the second driving voltage line VDL.

Each of the first to sixth transistors T1 to T6 may be a metal-oxide-semiconductor field effect transistor (MOSFET). For example, each of the first to sixth transistors T1 to T6 may be, but is not limited to, a p-type MOSFET. Each of the first to sixth transistors T1 to T6 may be an n-type MOSFET. Alternatively, some of the first to sixth transistors T1 to T6 may be p-type MOSFETs, and the other transistors may be n-type MOSFETs.

Although the first sub-pixel SP1 includes the six transistors T1 to T6 and the two capacitors CP1 and CP2 in the example shown in FIG. 15, it should be noted that the equivalent circuit diagram of the first sub-pixel SP1 is not limited to that shown in FIG. 15. For example, the numbers of the transistors and the capacitors of the first sub-pixel SP1 are not limited to those shown in FIG. 15.

In one or more embodiments, the equivalent circuit diagram of the second sub-pixel SP2 and the equivalent circuit diagram of the third sub-pixel SP3 may be substantially identical to the equivalent circuit diagram of the first sub-pixel SP1 described above with reference to FIG. 15; and, therefore, the redundant descriptions will be omitted.

FIG. 16 is a view showing a layout of a display panel according to one or more embodiments of the present disclosure.

Referring to FIG. 16, the display area DAA of the display panel 100 according to the embodiment includes a plurality of pixels PX arranged in a matrix. The non-display area NDA of the display panel 100 according to the embodiment includes the scan driver 610, the light-emitting driver 620, the data driver 700, a first distribution circuit 710, a second distribution circuit 720, a first pad area PDA1, and a second pad area PDA2.

The scan driver 610 may be located on a first side of the display area DAA, and the light-emitting driver 620 may be located on a second side of the display area DAA. For example, the scan driver 610 may be located on one side of the display area DAA in the first direction DR1, and the light-emitting driver 620 may be located on the opposite side of the display area DAA in the first direction DR1. It should be understood, however, that the present disclosure is not limited thereto. The scan driver 610 and the light-emitting driver 620 may be located on both the first and second sides of the display area DAA.

The first pad area PDA1 may include a plurality of first pads PD1 connected to pads or bumps of the circuit board 300 through a conductive adhesive member. The first pad area PDA1 may be located on a third side of the display area DAA. For example, the first pad area PDA1 may be located on one side of the display area DAA in the second direction DR2. The first pad area PDA1 may be located on the outer side of the data driver 700 in the second direction DR2.

The second pad area PDA2 may include a plurality of second pads PD2, which is test pads for testing whether the display panel 100 operates normally. The plurality of second pads PD2 may be connected to a jig or a probe pin during a test process, or may be connected to a circuit board for testing. The circuit board for testing may be a printed circuit board (PCB) made of a rigid material or a flexible printed circuit board made (FPCB) of a flexible material.

The second pad area PDA2 may be located on a fourth side of the display area DAA. For example, the second pad area PDA2 may be located on the opposite side of the display area DAA in the second direction DR2. The second pad area PDA2 may be located on the outer side of the second distribution circuit 720 in the second direction DR2.

The first distribution circuit 710 distributes data voltages applied via the first pad area PDA1 to a plurality of data lines DL. For example, the first distribution circuit 710 may divide the data voltages applied via one first pad PD1 of the first pad area PDA1 into P data lines DL, thereby reducing the number of the plurality of first pads PD1, where P is a positive integer equal to or greater than two. The first distribution circuit 710 may be located on the third side of the display area DAA of the display panel 100. For example, the first distribution circuit 710 may be located on one side of the display area DAA in the second direction DR2.

The second distribution circuit 720 distributes signals applied through the second pad area PDA2 to the scan driver 610, the light-emitting driver 620, and the data lines DL. The second pad area PDA2 and the second distribution circuit 720 may be elements to test the operation of each of the pixels PX in the display area DAA. The second distribution circuit 720 may be located on a fourth side of the display area DAA of the display panel 100. For example, the second distribution circuit 720 may be located on the opposite side of the display area DAA in the second direction DR2.

In a cathode connection area CCA, a second electrode CAT (see FIG. 19) of a display element layer EML (see FIG. 19) may be connected to the first supply voltage line VSL in the non-display area NDA. The cathode connection area CCA may be located on at least one outer side of the display area DA. For example, the cathode connection area CCA may be located on the outer side of at least one of the left side, the right side, the upper side and the lower side of the display area DAA. Alternatively, the cathode connection area CCA may be located to be around (e.g., to surround) the display area DAA as shown in FIG. 16 in order to reduce deviations of the first supply voltage VSS due to a voltage drop (IR drop) or a voltage rise (IR rising) of the second electrode CAT in the display area DAA.

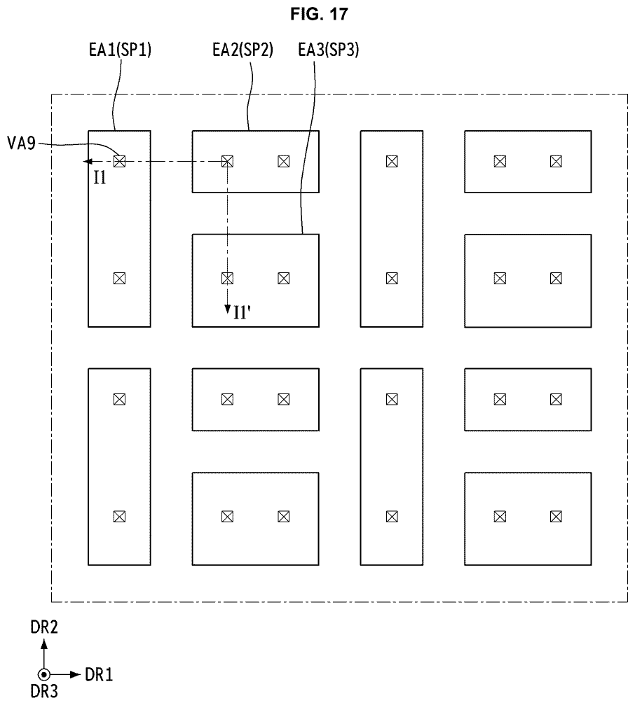

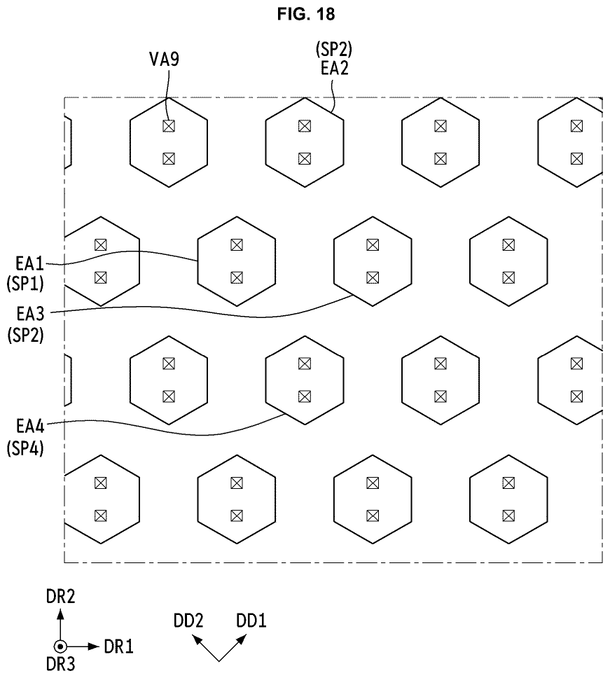

FIG. 17 is a view showing a layout of the display area of FIG. 16. FIG. 18 is a view showing a layout of the display area of FIG. 16.

Referring to FIGS. 17 and 18, each of the plurality of pixels PX includes a first light-emitting area EA1 that is the light-emitting area of the first sub-pixel SP1, a second light-emitting area EA2 that is the light-emitting area of the second sub-pixel SP2, and a third light-emitting area EA3 that is the light-emitting area of the third sub-pixel SP3.

The first light-emitting area EA1, the second light-emitting area EA2, and the third light-emitting area EA3 may have a rectangular shape, or a hexagonal shape as shown in FIGS. 17 and 18 when viewed from the top. It should be understood, however, that the present disclosure is not limited thereto. The first light-emitting area EA1, the second light-emitting area EA2, and the third light-emitting area EA3 may have a polygonal shape other than a rectangle or a hexagon, a circular shape, an elliptical shape or an irregular shape when viewed from the top.

As shown in FIG. 17, in each of the plurality of pixels PX, the first light-emitting area EA1 and the second light-emitting area EA2 may be adjacent to each other in the first direction DR1. In one or more embodiments, the first light-emitting area EA1 and the third light-emitting area EA3 may be adjacent to each other in the first direction DR1. In one or more embodiments, the second light-emitting area EA2 and the third light-emitting area EA3 may be adjacent to each other in the second direction DR2. The first light-emitting area EA1, the second light-emitting area EA2, and the third light-emitting area EA3 may have different areas.

Alternatively, as shown in FIG. 18, light-emitting areas EA1, EA2, EA3, and EA4 may have a hexagonal shape when viewed from the top. In this instance, the first light-emitting area EA1 and the third light-emitting area EA3 may be adjacent to each other in the first direction DR1, and the second light-emitting area EA2 and the fourth light-emitting area EA4 may be adjacent to each other in the second direction DR2. In one or more embodiments, the first light-emitting area EA1 and the second light-emitting area EA2 may be adjacent to each other in a first diagonal direction DD1, and the second light-emitting area EA2 and the third light-emitting area EA3 may be adjacent to each other in a second diagonal direction DD2. In one or more embodiments, the first light-emitting area EA1 and the fourth light-emitting area EA4 may be adjacent to each other in the second diagonal direction DD2, and the third light-emitting area EA3 and the fourth light-emitting area EA4 may be adjacent to each other in the first diagonal direction DD1. The first diagonal direction DD1 refer to a direction between the first direction DR1 and the second direction DR2, and refers to a direction inclined by 45 degrees relative to the first direction DR1 and the second direction DR2. The second diagonal direction DD2 may be orthogonal to the first diagonal direction DD1.

The first sub-pixel SP1 may output first light, the second sub-pixel SP2 may output second light, and the third sub-pixel SP3 may output third light. The first light may be light of a blue wavelength range, the second light may be light of a green wavelength range, and the third light may be light of a red wavelength range. For example, the blue wavelength range may refer that the main peak wavelength of light lies in the wavelength range of approximately 370 nm to 460 nm, the green wavelength range may refer that the main peak wavelength of light lies in the wavelength range of approximately 480 nm to 560 nm, and the red wavelength range may refer to that the main peak wavelength of light lies in the wavelength range of approximately 600 nm to 750 nm.

Each of the plurality of pixels PX may include three light-emitting areas EA1, EA2, and EA3 as shown in FIG. 17, or may include four light-emitting areas EA1, EA2, EA3, and EA4 as shown in FIG. 18. In this instance, the fourth light-emitting area EA4 may output the same second light as the second light-emitting area EA2. It should be understood, however, that the present disclosure is not limited thereto.

The light-emitting areas of the plurality of pixels PX may have a stripe pattern in which the light-emitting areas are arranged along the first direction DR1, a PENTILE® matrix in which the light-emitting areas are arranged in a diamond pattern as shown in FIG. 18, or a hexagonal structure in which the light-emitting areas are arranged in a hexagonal pattern. This PENTILE® arrangement structure may be referred to as an RGBG matrix structure (e.g., a PENTILE® matrix structure or an RGBG structure (e.g., a PENTILE® structure)). PENTILE® is a registered trademark of Samsung Display Co., Ltd., Republic of Korea.

FIG. 19 is a cross-sectional view of the display panel, taken along the line I1-I1′ of FIG. 17.

Referring to FIG. 19, the display panel 100 includes a semiconductor backplane SBP, a light-emitting element backplane EBP, a display element layer EML, an encapsulation layer TFE, an optical layer OPL, a cover layer CVL, and a polarizer POL.

The semiconductor backplane SBP includes a semiconductor substrate SSUB including a plurality of pixel transistors PTR, a plurality of semiconductor insulating films covering the plurality of pixel transistors PTR, and a plurality of contact terminals CTE that are electrically connected to the pixel transistors PTR, respectively. The plurality of pixel transistors PTR may be the first to sixth transistors T1 to T6 described above with reference to FIG. 15.

The semiconductor substrate SSUB may be a silicon substrate, a germanium substrate, or a silicon-germanium substrate. The semiconductor substrate SSUB may be a substrate doped with first-type impurities. A plurality of well areas WA may be arranged in the upper surface of the semiconductor substrate SSUB. The well areas WA may be doped with second-type impurities. The second-type impurities may be different from the first-type impurities. For example, when the first-type impurities are p-type impurities, the second-type impurities may be n-type impurities. Alternatively, when the first-type impurities are n-type impurities, the second-type impurities may be p-type impurities.

Each of the well areas WA includes a source region SA associated with a source electrode of a pixel transistor PTR, a drain region DA associated with a drain electrode thereof, and a channel region CH between the source region SA and the drain region DA.

A bottom insulating layer BINS may be located between the gate electrode GE and the well areas WA. Side insulating films SINS may be located on the side surfaces of the gate electrode GE. The side insulating films SINS may be located on the bottom insulating layer BINS.

Each of the source region SA and the drain region DA may be doped with the first-type impurities. The gate electrode GE of the pixel transistor PTR may overlap with the well area WA in the third direction DR3 which is the thickness direction of the semiconductor substrate SSUB. The channel region CH may overlap with the gate electrode GE in the third direction DR3. The source area SA may be located on one side of the gate electrode GE, and the drain area DA may be located on the opposite side of the gate electrode GE.

Each of the plurality of well areas WA may further include a first low-concentration impurity region LDD1 located between the channel region CH and the source region SA, and a second low-concentration impurity region LDD2 located between the channel region CH and the drain region DA. The first low-concentration impurity region LDD1 may have a lower impurity concentration than the source region SA due to the bottom insulating layer BINS. The second low-concentration impurity region LDD2 may have a lower impurity concentration than the drain region DA due to the bottom insulating layer BINS. The distance between the source region SA and the drain region DA may be increased by the first low-concentration impurity region LDD1 and the second low-concentration impurity region LDD2. Accordingly, the length of the channel region CH of each of the pixel transistors PTR may be increased.

A first semiconductor insulating layer SINS1 may be located on the semiconductor substrate SSUB covering the pixel transistor PTR. A second semiconductor insulating layer SINS2 may be located on the first semiconductor insulating layer SINS1.

A plurality of contact terminals CTE may be located on the second semiconductor insulating layer SINS2. Each of the plurality of contact terminals CTE may be connected to one of the gate electrode GE, the region SA, or the drain region DA of each of the pixel transistors PTR through a hole penetrating the first semiconductor insulating layer SINS1 and the second semiconductor insulating layer INS2. The contact terminals CTE may be made of copper (Cu), aluminum (Al), tungsten (W), molybdenum (Mo), chromium (Cr), gold (Au), titanium (Ti), nickel (Ni), and/or neodymium (Nd), and/or an alloy containing one or more of these.

A third semiconductor insulating layer SINS3 may be located on the side surface of each of the contact terminals CTE. The upper surface of each of the contact terminals CTE may not be covered by the third semiconductor insulating layer SINS3 but may be exposed.

Each of the first semiconductor insulating layer SINS1, the second semiconductor insulating layer SINS2, and the third semiconductor insulating layer SINS3 may be formed of, but is not limited to, a silicon carbon nitride (SiCN) and/or silicon oxide (SiOx)-based inorganic film.

The semiconductor substrate SSUB may be replaced with a glass substrate and/or a polymer resin substrate such as polyimide. In this instance, thin-film transistors may be arranged on a glass substrate and/or a polymer resin substrate. The glass substrate may be a rigid substrate that is not bent, while the polymer resin substrate may be a flexible substrate that can be bent or curved.

The light-emitting element backplane EBP includes a plurality of conductive layers ML1 to ML8, a plurality of vias VA1 to VA9, and a plurality of insulating layers INS1 to INS9. In one or more embodiments, the light-emitting element backplane EBP includes a plurality of insulating layers INS1 to INS9 located between the first to eighth conductive layers ML1 to ML8.

The first to ninth insulating layers INS1 to INS9 may insulate the first to eighth conductive layers ML1 to ML8. The first to eighth conductive layers ML1 to ML8 may implement a circuit of a first sub-pixel SP1 shown in FIG. 15 by connecting a plurality of contact terminals CTE exposed from the semiconductor backplane SBP.

For example, the first to sixth transistors T1 to T6 are only formed in the semiconductor backplane SBP, and the connection of the first to sixth transistors T1 to T6 and the first capacitor CP1 and the second capacitor CP2 are made through the first to eighth conductive layers ML1 to ML8. In one or more embodiments, the connection between the drain region corresponding to the drain electrode of the fourth transistor T4, the source region corresponding to the source electrode of the fifth transistor T5, and a first electrode AND of the light-emitting element LE is also made through the first to eighth conductive layers ML1 to ML8.

The first to eighth conductive layers ML1 to ML8 and the first to eighth vias VA1 to VA8 may be made of substantially the same material. The first to eighth conductive layers ML1 to ML8 and the first to eighth vias VA1 to VA8 may be made of copper (Cu), aluminum (Al), tungsten (W), molybdenum (Mo), chromium (Cr), gold (Au), titanium (Ti), nickel (Ni), and/or neodymium (Nd), and/or an alloy containing one of these. The first to eighth vias VA1 to VA8 may be made of substantially the same material. The first to eighth insulating layers INS1 to INS8 may be formed as inorganic films such as silicon oxide films, but the present disclosure is not limited thereto.

The ninth insulating layer INS9 may be located over the eighth insulating layer INS8 and the eighth conductive layer ML8. The ninth insulating layer INS9 may be formed as an inorganic film such as a silicon oxide (SiOx) film, but the present disclosure is not limited thereto.

Each of the ninth vias VA9 may penetrate through the ninth insulating layer INS9 to be connected to the exposed eighth conductive layer ML8. The ninth vias VA9 may be made of copper (Cu), aluminum (Al), tungsten (W), molybdenum (Mo), chromium (Cr), gold (Au), titanium (Ti), nickel (Ni), and/or neodymium (Nd), and/or an alloy containing one of these.

The display element layer EML may be located on the light-emitting element backplane EBP. The display element layer EML may include tenth and eleventh insulating films INS10 and INS11, reflective electrodes RL, first electrodes AND, a light-emitting stack IL, a second electrode CAT, a pixel-defining layer PDL, and a plurality of trenches TRC.

The reflective electrodes RL may be arranged on the ninth insulating layer INS9. The reflective electrodes RL may include one or more reflective electrodes RL1, RL2, RL3, and RL4. For example, the reflective electrodes RL may include first to fourth reflective electrodes RL1, RL2, RL3, and RL4 as shown in FIG. 19.

The first reflective electrodes RL1 may be located on the ninth interlayer insulating layer INS9 and may be connected to the ninth via VA9. The second reflective electrodes RL2 may be located on the first reflective electrodes RL1, respectively. The third reflective electrodes RL3 may be located on the second reflective electrodes RL2, respectively. The fourth reflective electrodes RL4 may be located on the third reflective electrodes RL3, respectively.

In one or more embodiments, because the fourth reflective electrode RL4 is an electrode that substantially reflects light from the light-emitting elements LE, the thickness of the fourth reflective electrode RL4 may be greater than the thickness of the first reflective electrode RL1, the thickness of the second reflective electrode RL2, and the thickness of the third reflective electrode RL3. In one or more other embodiments, because the second reflective electrode RL2 is an electrode that substantially reflects light from the light-emitting elements LE, the thickness of the second reflective electrode RL2 may be greater than the thickness of the first reflective electrode RL1, the thickness of the third reflective electrode RL3, and the thickness of the fourth reflective electrode RL4.

The first to fourth reflective electrodes RL1 to RL4 may be made of copper (Cu), aluminum (Al), tungsten (W), molybdenum (Mo), chromium (Cr), gold (Au), titanium (Ti), nickel (Ni), and/or neodymium (Nd), and/or an alloy containing one of these. For example, the first reflective electrodes RL1 may include titanium nitride (TiN), the second reflective electrodes RL2 may include aluminum (Al), the third reflective electrodes RL3 may include titanium nitride (TiN), and the fourth reflective electrodes RL4 may include titanium (Ti).

A tenth interlayer insulating layer INS10 may be located on the ninth interlayer insulating layer INS9. The tenth interlayer insulating layer INS10 may be located between the reflective electrodes RL that are adjacent to each other. The tenth interlayer insulating layer INS10 may be a film for providing flat surfaces to the reflective electrodes RL. An eleventh interlayer insulating layer INS11 may be located on the tenth interlayer insulating layer INS10 and the reflective electrode layer RL.

The tenth interlayer insulating layer INS10 and the eleventh interlayer insulating layer INS11 may be formed of an inorganic film such as a silicon oxide (SiOx) film, but the present disclosure is not limited thereto.

The eleventh interlayer insulating layer INS11 may be an optical auxiliary layer for adjusting the resonance distance of light output from the light-emitting stack IL in at least one sub-pixel from among the first sub-pixel SP1, the second sub-pixel SP2, and the third sub-pixel SP3. The thickness of the eleventh interlayer insulating layer INS11 may be different in the first sub-pixel SP1, the second sub-pixel SP2, and the third sub-pixel SP3. Specifically, in order to adjust the distance from the reflective electrode layer RL to the second electrode CAT according to the main wavelength of light emitted from each of the first sub-pixel SP1, the second sub-pixel SP2, and the third sub-pixel SP3, the thickness of the eleventh interlayer insulating layer INS11 may be determined in each of the first sub-pixel SP1, the second sub-pixel SP2, and the third sub-pixel SP3.

For example, as shown in FIG. 19, the thickness of the eleventh interlayer insulating layer INS11 in the first sub-pixel SP1 may be greater than the thickness of the eleventh interlayer insulating layer INS11 in the second sub-pixel SP2, and the thickness of the eleventh interlayer insulating layer INS11 in the second sub-pixel SP2 may be greater than the thickness of the eleventh interlayer insulating layer INS11 in the third sub-pixel SP3. In this instance, the distance between the first electrode AND and the reflective electrode layer RL in the first sub-pixel SP1 may be greater than the distance between the first electrode AND and the reflective electrode layer RL in the second sub-pixel SP2. In one or more embodiments, the distance between the first electrode AND and the reflective electrode layer RL in the second sub-pixel SP2 may be greater than the distance between the first electrode AND and the reflective electrode layer RL in the third sub-pixel SP3.

Each of the tenth vias VA10 may be connected to the exposed reflective electrode layer RL by penetrating through the eleventh interlayer insulating layer INS11. The tenth vias VA10 may be made of copper (Cu), aluminum (Al), tungsten (W), molybdenum (Mo), chromium (Cr), gold (Au), titanium (Ti), nickel (Ni), and/or neodymium (Nd), and/or an alloy containing one or more of these. The thickness of the tenth via VA10 in the first sub-pixel SP1 may be greater than the thickness of the tenth via VA10 in the second sub-pixel SP2, and the thickness of the tenth via VA10 in the second sub-pixel SP2 may be greater than the thickness of the tenth via VA10 in the third sub-pixel SP3.

The first electrode AND of each of the light-emitting elements LE may be located on the eleventh interlayer insulating layer INS11 and may be connected to the tenth via VA10. The first electrode AND of each of the light-emitting elements LE may be connected to the drain area DA or the source area SA of the pixel transistor PTR through the tenth via VA10, the reflective electrodes RL, the first to ninth vias VA1 to VA9, the first to eighth metal layers ML1 to ML8, and the contact terminals CTE. The first electrode AND of each of the light-emitting elements LE may be made of copper (Cu), aluminum (Al), tungsten (W), molybdenum (Mo), chromium (Cr), gold (Au), titanium (Ti), nickel (Ni), and/or neodymium (Nd), and/or an alloy containing one or more of these. For example, the first electrode AND of each of the light-emitting elements LE may be titanium nitride (TiN).

The pixel-defining layer PDL may be located partially on the first electrode AND of each of the light-emitting elements LE. The pixel-defining layer PDL may cover the edge of the first electrode AND of each of the light-emitting elements LE. The pixel-defining layer PDL may define the first light-emitting areas EA1, the second light-emitting areas EA2, and the third light-emitting areas EA3. In each of the first light-emitting area EA1, the second light-emitting area EA2, and the third light-emitting area EA3, a light-emitting element LE including a first electrode AND, a light-emitting stack IL, and a second electrode CAT is placed.

A first light-emitting area EA1 may be defined as an area in the first sub-pixel SP1 where the first electrode AND, the light-emitting stack IL, and the second electrode CAT are sequentially stacked on one another to emit light. A second light-emitting area EA2 may be defined as an area in the second sub-pixel SP2 where the first electrode AND, the light-emitting stack IL, and the second electrode CAT are sequentially stacked on one another to emit light. A third light-emitting area EA3 may be defined as an area in the third sub-pixel SP3 where the first electrode AND, the light-emitting stack IL, and the second electrode CAT are sequentially stacked on one another to emit light.

The pixel-defining layer PDL may include first to third pixel-defining layers PDL1, PDL2, and PDL3. The first pixel-defining layer PDL1 may be located on the edge of the first electrode AND of each of the light-emitting elements LE, the second pixel-defining layer PDL2 may be located on the first pixel-defining layer PDL1, and the third pixel-defining layer PDL3 may be located on the second pixel-defining layer PDL2. The first pixel-defining layer PDL1, the second pixel-defining layer PDL2, and the third pixel-defining layer PDL3 may be formed of an inorganic film such as a silicon oxide (SiOx) film. Alternatively, the first pixel-defining layer PDL1 and the third pixel-defining layer PDL3 may be formed of an inorganic film such as a silicon nitride (SiNx) film, and the second pixel-defining layer PDL2 may be formed of an inorganic film such as a silicon oxide (SiOx) film. The thickness of the first pixel-defining layer PDL1, the second pixel-defining layer PDL2, and the third pixel-defining layer PDL3 may each be approximately 500 Å.

In order to prevent the first inorganic encapsulation film TFE1 from breaking due to step coverage, the first pixel-defining layer PDL1, the second pixel-defining layer PDL2 and the third pixel-defining layer PDL3 may have a cross-sectional structure in the form of stairs. Herein, the step coverage refers to a ratio of a thin film applied on an inclined portion to the thin film applied on a flat portion. The lower the step coverage is, the more likely it is that the thin film would break at the inclined portion.

Each of the plurality of trenches TRC may penetrate the first pixel-defining layer PDL1, the second pixel-defining layer PDL2, and the third pixel-defining layer PDL3. The eleventh interlayer insulating layer INS11 may be partially dug in each of the plurality of trenches TRC.

At least one trench TRC may be formed between the adjacent ones of the sub-pixels SP1, SP2, and SPX. Although two trenches TRC are formed between adjacent ones of the pixels SP1, SP2, and SPX in the example shown in FIG. 19, the present disclosure is not limited thereto.

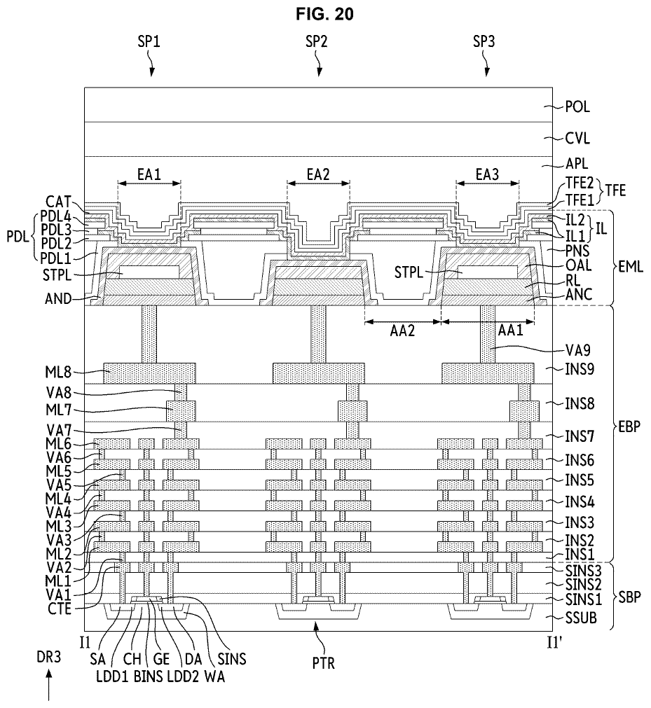

The light-emitting stack IL may include a plurality of stacks IL1, IL2, and IL3. Although the light-emitting stack IL has a three-tandem structure including a first stack layer IL1, a second stack layer IL2, and a third stack layer IL3 in the example shown in FIG. 19, the present disclosure is not limited thereto. For example, the light-emitting stack IL may have a two-tandem structure including two stack layers as shown in FIG. 20.

In a three-tandem structure, the light-emitting stack IL may have a tandem structure including a plurality of intermediate layers IL1, IL2, and IL3 emitting different lights. For example, the light-emitting stack IL may include the first stack layer IL1 that outputs the first light, the second stack layer IL2 that outputs the second light, and the third stack layer IL3 that outputs the third light. The first stack layer IL1, the second stack layer IL2, and the third stack layer IL3 may be sequentially stacked on one another.

The first stack layer IL1 may have a structure in which a first hole transport layer, a first light-emitting layer that emits the first light, and a first electron transport layer are sequentially stacked on one another. The second stack layer IL2 may have a structure in which a second hole transport layer, a second light-emitting layer that emits the second light, and a second electron transport layer are sequentially stacked on one another. The third stack layer IL3 may have a structure in which a third hole transport layer, a third organic light-emitting layer that emits the third light, and a third electron transport layer are sequentially stacked on one another.

A first charge generation layer may be located between the first stack layer IL1 and the second stack layer IL2 to supply holes to the second stack layer IL2 and electrons to the first stack layer IL1. The first charge generation layer may include an n-type charge generation layer that supplies electrons to the first stack layer IL1, and a p-type charge generation layer that supplies holes to the second stack layer IL2. The n-type charge generation layer may include a dopant of a metallic material.

A second charge generation layer may be located between the second stack layer IL2 and the third stack layer IL3 to supply holes to the third stack layer IL3 and electrons to the second stack layer IL2. The second charge generation layer may include an n-type charge generation layer that supplies electrons to the second stack layer IL2, and a p-type charge generation layer that supplies holes to the third stack layer IL3.

The first stack layer IL1 may be located on the first electrodes AND and the pixel-defining layer PDL. In each of the trenches TRC, a residual film RIL located on the bottom of the trench TRC may be made of the same material as the first stack layer IL1. Due to the trenches TRC, the first stack layer IL1 may be disconnected between the adjacent sub-pixels SP1, SP2, and SP3. The second stack layer IL2 may be located on the first stack layer IL1. Due to the trenches TRC, the second stack layer IL2 may be disconnected between the adjacent sub-pixels SP1, SP2, and SP3. In the trenches TRC, void or empty space ESS may be located between the residual film RIL and the second stack layer IL2. The third stack layer IL3 may be located on the second stack layer IL2. The third stack layer IL3 may not be disconnected by the trenches TRC and may cover the second stack layer IL2 in each of the trenches TRC.

In the three-tandem structure, each of the plurality of trenches TRC may be a feature that disconnects the first to third hole transport layers, the first charge generation layer, and the second charge generation layer of the first to third stack layers IL1, IL2, and IL3 of the display element layer EML between the adjacent sub-pixels SP1, SP2, and SP3. In one or more embodiments, in the two-tandem structure, each of the plurality of trenches TRC may be a feature that disconnects a charge generation layer, and a lower stack layer located between the lower stack layer and an upper stack layer.

In order to stably disconnect the first and second stack layers IL1 and IL2 of the display element layer EML between the adjacent pixels SP1, SP2, and SP3, the height of each of the plurality of trenches TRC may be greater than the height of the pixel-defining layer PDL. The height of each of the plurality of trenches TRC refers to the length measured in the third direction DR3. The height of the pixel-defining layer PDL refer to the length of the pixel-defining layer PDL in the third direction DR3. In order to disconnect the hole transparent layers and the charge generation layers of the light-emitting stack IL of the display element layer EML between the adjacent sub-pixels SP1, SP2, and SP3, there may be other features than the trenches TRC. For example, instead of the trenches TRC, partition walls in the form of an inverse taper may be arranged on the pixel-defining layer PDL.

In one or more embodiments, although the light-emitting stack IL that emits light is located in all of the first light-emitting area EA1, the second light-emitting area EA2, and the third light-emitting area EA3 in the example shown in FIG. 19, the present disclosure is not limited thereto. For example, the first light-emitting layer may be located in the first light-emitting area EA1 but not in the second light-emitting area EA2 or the third light-emitting area EA3, instead of the light-emitting stack IL. In one or more embodiments, the second light-emitting layer may be located in the second light-emitting area EA2 but not in the first light-emitting area EA1 or the third light-emitting area EA3. In one or more embodiments, the third light-emitting layer may be located in the third light-emitting area EA3 but not in the first light-emitting area EA1 or the second light-emitting area EA2. In this instance, the first to third color filters CF1, CF2, and CF3 of the optical layer OPL may be eliminated.

The second electrode CAT may be located on the light-emitting stack IL. The second electrode CAT may be located on the third stack layer IL3 in each of a plurality of trenches TRC. The second electrode CAT may be formed of a transparent conductive material (TCP) such as ITO and/or IZO that can transmit light, or a semi-transmissive conductive material such as magnesium (Mg), silver (Ag), or an alloy of magnesium (Mg) and silver (Ag). When the second electrode CAT is formed of a semi-transmissive conductive material, the light extraction efficiency can be increased by using microcavities in each of the first to third sub-pixels SP1, SP2, and SP3.

The encapsulation layer TFE may be located on the display element layer EML. The encapsulation layer TFE may include one or more inorganic films TFE1, TFE2, and TFE3 to prevent permeation of oxygen or moisture into the display element layer EML. The first inorganic encapsulation film TFE1 may be located on the second electrode CAT, the second inorganic encapsulation film TFE2 may be located on the first inorganic encapsulation film TFE1, and the third inorganic encapsulation film TFE3 may be located on the second inorganic encapsulation film TFE2. The first inorganic encapsulation film TFE1, the second inorganic encapsulation film TFE2, and the third inorganic encapsulation film TFE3 may be made up of multiple layers in which one or more inorganic layers of a silicon nitride layer (SiNx), a silicon oxynitride layer (SiON), a silicon oxide layer (SiOx), a titanium oxide layer (TiOx), and/or an aluminum oxide layer (AlOx) are alternately stacked on one another.

In one or more embodiments, the encapsulation layer TFE may include at least one organic film to protect the display element layer EML from particles such as dust. At least one organic film of the encapsulating layer TFE may be located between the first inorganic encapsulation film TFE1 and the second inorganic encapsulation film TFE2. At least one organic film of the encapsulation layer TFE may be a monomer. Alternatively, the at least one organic film of the encapsulation layer TFE may be an acryl resin, an epoxy resin, a phenolic resin, a polyamide resin and/or a polyimide resin.

An adhesive layer ADL may adhere the encapsulation layer TFE to the optical layer OPL. The adhesive layer ADL may be a double-sided adhesive member. In one or more embodiments, the adhesive layer ADL may be a transparent adhesive member such as a transparent adhesive and a transparent adhesive resin.

The optical layer OPL includes a plurality of color filters CF1, CF2, and CF3, a plurality of lenses LNS, and a filling layer FIL. The plurality of color filters CF1, CF2, and CF3 may include first to third color filters CF1, CF2, and CF3. The first to third color filters CF1, CF2, and CF3 may be arranged on the adhesive layer ADL.

The first color filter CF1 may be in line with the first light-emitting area EA1 of the first sub-pixel SP1. The first color filter CF1 may transmit light of the first color, i.e., light in the blue wavelength range. The blue wavelength range may be approximately 370 nm to 460 nm. Therefore, the first color filter CF1 may transmit light of the first color from among the lights emitted from the first light-emitting area EA1.

The second color filter CF2 may be in line with the second light-emitting area EA2 of the second sub-pixel SP2. The second color filter CF2 may transmit light of the second color, i.e., light in the green wavelength range. The green wavelength range may be approximately 480 nm to 560 nm. Therefore, the second color filter CF2 may transmit light of the second color from among the lights emitted from the second light-emitting area EA2.

The third color filter CF3 may be in line with the third light-emitting area EA3 of the third sub-pixel SP3. The third color filter CF3 may transmit light of the third color, i.e., light in the red wavelength range. The red wavelength range may be approximately 600 nm to 750 nm. Therefore, the third color filter CF3 may transmit light of the third color from among the lights emitted from the third light-emitting area EA3.

The lenses LNS may be arranged on the first color filter CF1, the second color filter CF2, and the third color filter CF3, respectively. Each of the lenses LNS may be a structure for increasing the ratio of light directed to the front side of the light source LS. Each of the lenses LNS may have a cross-sectional shape that is convex upward.

The filling layer FIL may be located on a plurality of lenses LNS. The filling layer FIL may have a suitable refractive index (e.g., a predetermined refractive index) so that light travels in the third direction DR3 at the interface between the plurality of lenses LNS and the filling layer FIL. In one or more embodiments, the filling layer FIL may be a planarization layer. The filling layer FIL may be an organic film such as an acryl resin, an epoxy resin, a phenolic resin, a polyamide resin, and/or a polyimide resin.

The cover layer CVL may be located on the filling layer FIL. The cover layer CVL may be a glass substrate or a polymer resin such as a resin. If the cover layer CVL is a glass substrate, it may be attached to the filling layer FIL. In this instance, the filling layer FIL may adhere the cover layer CVL. If the cover layer CVL is a glass substrate, it may work as an encapsulation substrate. If the cover layer CVL is a polymer resin such as a resin, it may be applied directly on the filling layer FIL.

The polarizer (e.g., the polarization member POL) may be located on a surface of the cover layer CVL. The polarizer may be a structure for preventing deterioration of visibility due to reflection of external light. The polarizer may include a linear polarizer and a retardation film. For example, the retardation film may be a λ/4 plate (quarter-wave plate), but the present disclosure is not limited thereto. If visibility is sufficiently improved by the first to third color filters CF1, CF2 and CF3 regardless of reflection of external light, the polarizer (e.g., the polarization member POL) may be eliminated.

FIG. 20 is a cross-sectional view of the display panel, taken along the line I1-I1′ of FIG. 17.

The embodiment of FIG. 20 is different from the embodiment of FIG. 19 in that a first electrode AND of each of the light-emitting elements LE is electrically connected to side surfaces of a connection electrode ANC connected to the eighth conductive layer ML8. In one or more embodiments, the embodiment of FIG. 20 differs from the embodiment of FIG. 19 in that the trenches TRC are eliminated, and instead, a third pixel-defining layer PDL3 and a fourth pixel-defining layer PDL4 have a cross-sectional structure in the shape of an eave or a mushroom. The redundant descriptions will be omitted.

Referring to FIG. 20, a plurality of connection electrodes ANC may be arranged on first portions AA1 of the ninth insulating layer INS9, respectively. The connection electrodes ANC may be arranged on the first portions AA1 of the ninth insulating layer INS9, respectively. The plurality of connection electrodes ANC may be made of copper (Cu), aluminum (Al), tungsten (W), molybdenum (Mo), chromium (Cr), gold (Au), titanium (Ti), nickel (Ni), and/or neodymium (Nd), an alloy containing one or more of these, and/or transparent conductive oxide. For example, the connection electrodes ANC may include, but is not limited to, titanium (Ti), titanium nitride (TiN), indium tin oxide (ITO), and/or indium zinc oxide (IZO).

A plurality of reflective electrodes RL may be located on a plurality of connection electrodes ANC, respectively. The reflective electrodes RL may be arranged on the connection electrodes ANC, respectively. The plurality of reflective electrodes RL may be made of copper (Cu), aluminum (Al), tungsten (W), molybdenum (Mo), chromium (Cr), gold (Au), titanium (Ti), nickel (Ni), and/or neodymium (Nd), and/or an alloy containing one or more of these. For example, each of the plurality of reflective electrodes RL may include aluminum (Al) having high reflectivity.

A plurality of optical auxiliary layers OAL may be located on a plurality of reflective electrodes RL, respectively. The optical auxiliary layers OAL may be located on the reflective electrodes RL, respectively. The optical auxiliary layers OAL may be formed of an inorganic film of silicon oxide (SiOx) and/or the like, but the present disclosure is not limited thereto.

A step layer STPL may be located on a reflective electrode RL in each of the first light-emitting area EA1 and the third light-emitting area EA3, and an optical auxiliary layer OAL may be located on the step layer STPL. In the second light-emitting area EA2, only the optical auxiliary layer OAL may be located on the reflective electrode RL. The thicknesses of the optical auxiliary layer OAL may be substantially constant in the first light-emitting area EA1, the second light-emitting area EA2 and the third light-emitting area EA3.

Due to the step layer STPL, the distance between the reflective electrode RL and the first electrode AND in the first light-emitting area EA1 and the third light-emitting area EA3 may be greater than the distance between the reflective electrode RL and the first electrode AND in the second light-emitting area EA2. The thickness of the step layer STPL and the thickness of the optical auxiliary layer OAL may be determined based on the wavelength and resonance distance of the light emitted from the first stack layer IL1 of the light-emitting stack IL and the wavelength and resonance distance of the light emitted from the second stack layer IL2.

Each of the light-emitting elements LE may include a first electrode AND, a light-emitting stack IL, and a second electrode CAT.

The first electrode AND of each of the light-emitting elements LE may be arranged on the respective optical auxiliary layers OAL. Because the connection electrode ANC, the reflective electrode RL, and the optical auxiliary layer OAL are sequentially stacked on one another, the first electrode AND of each of the light-emitting elements LE may be located on the upper surface and the side surfaces of the optical auxiliary layer OAL, the side surfaces of the reflective electrode RL, and the side surfaces of the connection electrode ANC. In this manner, the first electrode AND of each of the light-emitting elements LE may come into contact with the side surfaces of the electrode RL and the side surfaces of the connection electrode ANC and may be electrically connected to them. Therefore, it is possible to reduce mask processes compared to a structure in which the first electrode AND of each of the light-emitting elements LE is connected to the reflective electrode RL exposed through a hole penetrating the optical auxiliary layer OAL. As a result, fabrication cost may be reduced and the fabrication efficiency may be increased.

The first electrode AND of each of the light-emitting elements LE may be connected to the drain area DA or the source area SA of the pixel transistor PTR through the connection electrode ANC, the first to ninth vias VA1 to VA9, the first to eighth metal layers ML1 to ML8, and the contact terminal CTE.

The ninth insulating layer INS9 may include a first portion AA1 that overlaps with the connection electrode ANC in the third direction DR3, and a second portion AA2 that does not overlap with the connection electrode ANC in the third direction DR3. The thickness of the first portion AA1 and the thickness of the second portion AA2 of the ninth insulating layer INS9 may be substantially equal to each other (e.g., may be substantially the same).

Alternatively, the thickness of the first portion AA1 of the ninth insulating layer INS9 may be greater than the thickness of the second portion AA2. In this instance, a side surface of the first portion AA1 of the ninth insulating layer INS9 may be exposed, and the first electrode AND of each of the light-emitting elements LE may be located on the exposed side surface of the first portion AA1 of the ninth insulating layer INS9.

The first electrode AND of each of the light-emitting elements LE may be made of copper (Cu), aluminum (Al), tungsten (W), molybdenum (Mo), chromium (Cr), gold (Au), titanium (Ti), nickel (Ni), and neodymium (Nd), and/or an alloy containing one or more of these, and/or a transparent conductive oxide. For example, the first electrode AND of each of the light-emitting elements LE may include, but is not limited to, titanium nitride (TiN), indium tin oxide (ITO), and/or indium zinc oxide (IZO).

The pixel-defining layer PDL may be located partially on the first electrode AND of each of the light-emitting elements LE. The pixel-defining layer PDL may cover the edge of the first electrode AND of each of the light-emitting elements LE. The pixel-defining layer PDL may define the first light-emitting areas EA1, the second light-emitting areas EA2, and the third light-emitting areas EA3.

The pixel-defining layer PDL may include first to fourth pixel-defining layers PDL1, PDL2, PDL3, and PDL4.

The first pixel-defining layer PDL1 may be located on the first electrode AND of each of the light-emitting elements LE. Specifically, the first pixel-defining layer PDL1 may cover a part of the upper surface of the first electrode AND located on the optical auxiliary layer OAL. In one or more embodiments, the first pixel-defining layer PDL1 may cover the first electrode AND which is located on the side surfaces of the connection electrode ANC, the side surfaces of the reflective electrode RL, and the side surfaces of the optical auxiliary layer OAL. The first pixel-defining layer PDL1 may be located on the upper surface of the second portion AA2 of the ninth insulating layer INS9.

A planarization layer PNS is a film for providing a flat surface over the connection electrode ANC, the reflective electrode RL, and the optical auxiliary layer OAL.

The planarization layer PNS may be located on the first pixel-defining layer PDL1 that covers the first electrode AND located on the side surfaces of the connection electrode ANC, the side surfaces of the reflective electrode RL, and the side surfaces of the optical auxiliary layer OAL. The planarization layer PNS may be located on the first pixel-defining layer PDL1 located on the second portion AA2 of the ninth insulating layer INS9.

The planarization layer PNS may be located between the connection electrodes ANC adjacent to each other in the first direction DR1 or the second direction DR2. The planarization layer PNS may be located between the reflective electrodes RL adjacent to each other in the first direction DR1 or the second direction DR2. The planarization layer PNS may be located between the optical auxiliary layer OAL adjacent to each other in the first direction DR1 or the second direction DR2.

While there is no step layer STPL in the second light-emitting area EA2, a step layer STPL is located in each of the first light-emitting area EA1 and the third light-emitting area EA3. Due to this, the height of the connection electrode ANC, the reflecting electrode RL, and the optical auxiliary layer OAL in the second light-emitting area EA2 may be smaller than the height of the connection electrode ANC, the reflective electrode RL, the step layer STPL, and the optical auxiliary layer OAL in each of the first light-emitting area EA1 and the third light-emitting area EA3. Therefore, the planarization layer PNS may cover the upper surface of the first pixel-defining layer PDL1 located on the upper surface of the first electrode AND located in the second light-emitting area EA2.

In contrast, the upper surface of the planarization layer PNS may be flatly connected to the upper surfaces of the first electrode AND located in the first light-emitting area EA1 and the third light-emitting area EA3. That is to say, the planarization layer PNS may not cover the upper surface of the first pixel-defining layer PDL1 located on the upper surface of the first electrode AND located in each of the first light-emitting area EA1 and the third light-emitting area EA3.

The second pixel-defining layer PDL2 may be located on the first pixel-defining layer PDL1 and the planarization layer PNS, the third pixel-defining layer PDL3 may be located on the second pixel-defining layer PDL2, and the fourth pixel-defining layer PDL4 may be located on the third pixel-defining layer PDL3. The first pixel-defining layer PDL1 and the third pixel-defining layer PDL3 are formed of inorganic films such as silicon nitride (SiNx) films, while the second pixel-defining layer PDL2, the fourth pixel-defining layer PDL4, and the planarization layer PNS may be formed of inorganic films such as silicon oxide (SiOx) films. Because the first pixel-defining layer PDL1 is made of a different material from the planarization layer PNS, it may work as a stopper in a process of chemically and mechanically polishing the planarization layer PNS.

When the planarization layer PNS as well as the second pixel-defining layer PDL2 are formed of an inorganic film such as a silicon oxide (SiOx) film, the planarization layer PNS and the second pixel-defining layer PDL2 may be formed as a single film.

Because the length of the third pixel-defining layer PDL3 in a direction (e.g., the first direction DR1 or the second direction DR2) is smaller than the length of the fourth pixel-defining layer PDL4 in the direction (e.g., the first direction DR1 or the second direction DR2), the lower surface of the fourth pixel-defining layer PDL4 may be exposed without being covered by the third pixel-defining layer PDL3. In other words, the third pixel-defining layer PDL3 and the fourth pixel-defining layer PDL4 may have a cross-sectional structure in the shape of an eave or a mushroom.

The light-emitting stack IL may be located on the first electrode AND and the pixel-defining layer PDL. The light-emitting stack IL may include a first stack layer IL1 and a second stack layer IL2 that emit different lights. When the light-emitting stack IL has a two-tandem structure, one of the first stack layer IL1 or the second stack layer IL2 may emit light including a wavelength range of one of the first light, the second light, or the third light, while the other one may emit light including wavelength ranges of the other two lights. For example, the first stack layer IL1 may emit light including the wavelength range of the first light and the wavelength range of the third light, while the second stack layer IL2 may emit light including the wavelength range of the second light. The first light may be light of a blue wavelength range, the second light may be light of a green wavelength range, and the third light may be light of a red wavelength range.

A charge generation layer may be located between the first stack layer IL1 and the second stack layer IL2 to supply holes to the second stack layer IL2 and electrons to the first stack layer IL1. The charge generation layer may include an n-type charge generation layer that supplies electrons to the first stack layer IL1, and a p-type charge generation layer that supplies holes to the second stack layer IL2. The n-type charge generation layer may include a dopant of a metallic material.

Because the first stack layer IL1 is not formed on the lower surface of the fourth pixel-defining layer PDL4 that is exposed and not covered by the third pixel-defining layer PDL3, it may be broken by the cross-sectional structure of the third pixel-defining layer PDL3 and the fourth pixel-defining layer PDL4 in the shape of the eave or mushroom. When this happens, the first hole transport layer of the first stack layer IL1 as well as the charge generation layer located between the first stack layer IL1 and the second stack layer IL2 may also be disconnected. In one or more embodiments, although the second stack layer IL2 is connected without being disconnected in the example shown in FIG. 20, the second hole transport layer of the second stack layer IL2 may be disconnected while the second electron transport layer of the second stack layer IL2 may be connected without being disconnected. Therefore, it is possible to prevent leakage current from flowing between the adjacent light-emitting areas EA1, EA2, and EA3 through the first hole transport layer of the first stack layer IL1, the second hole transport layer of the second stack layer IL2, and the charge generation layer. Accordingly, it is possible to avoid that the light-emitting stack IL in the adjacent light-emitting areas EA1, EA2, and EA3 are affected by the current and emit light other than the originally intended light.

Although the light-emitting stack IL has a two-tandem structure including two stack layers IL1 and IL2 in the example shown in FIG. 20, the present disclosure is not limited thereto. For example, the light-emitting stack IL may have a three-tandem structure including three stack layers as shown in FIG. 19. In this instance, the height of the third pixel-defining layer PDL3 may be adjusted so that the charge generation layer between the first stack layer IL1 and the second stack layer IL2, and the charge generation layer between the second stack layer IL2 and the third stack layer IL3 are disconnected. Alternatively, like the embodiment shown in FIG. 19, in the embodiment of FIG. 20, trenches TRC penetrating the first pixel-defining layer PDL1, the planarization layer PNS, the second pixel-defining layer PDL2, and the third pixel-defining layer PDL3 may be added. In this instance, the trenches TRC may penetrate at least partially the ninth insulating layer INS9, but the present disclosure is not limited thereto.

Although one or more embodiments of the present disclosure have been described with reference to the accompanying drawings, those of ordinary skill in the art to which the present disclosure pertains will understand that the subject matter of the present disclosure may be embodied in different forms and should not be construed as being limited to one or more embodiments set forth herein. It therefore will be understood that one or more embodiments described herein are just illustrative but not limitative in all aspects.

What is claimed is:

1. An optical device comprising:
a light source comprising a plurality of first pixels configured to emit light;
a polarizer configured to control polarization of light output from the light source;
a spatial light modulator comprising a plurality of second pixels configured to display a light modulation pattern to modulate a phase of light passing through the polarizer; and
a controller configured to control the plurality of first pixels and the plurality of second pixels based on an input image.

2. The optical device of claim 1, wherein the plurality of first pixels is associated with the plurality of second pixels, respectively.

3. The optical device of claim 1, wherein the controller is further configured to:
generate target color data for each pixel color and target phase data for each pixel phase based on the input image,
generate target hologram data comprising information on the color for each pixel and information on the phase for each pixel by combining the target color data with the target phase data,
generate light intensity data for the color for each pixel and light modulation data for the phase for each pixel based on the target hologram data,
control the light source based on the light intensity data, and
control the spatial light modulator based on the light modulation data.

4. The optical device of claim 3, wherein the controller comprises an artificial neural network configured to generate the target phase data based on the target color data,
wherein the generating the target color data and the target phase data based on the input image comprises:
extracting information on color for each pixel from the input image to generate the target color data; and
inputting the target color data into the artificial neural network to generate target phase data including information on phase for each pixel as an output thereof.

5. The optical device of claim 4, further comprising:
a sensor configured to detect a holographic image generated by modulating the phase by the spatial light modulator.

6. The optical device of claim 5, wherein the controller is further configured to train the artificial neural network using the target hologram data and a hologram image.

7. The optical device of claim 6, wherein the training the artificial neural network comprises:
supervised training the artificial neural network using the target hologram data as correct answer data.

8. The optical device of claim 3, wherein the generating the light intensity data for the color for each pixel and the light modulation data for the phase for each pixel based on the target hologram data comprises:
extracting the light intensity data including the color for each pixel from the target hologram data; and
performing a function transformation on the target hologram data to generate the light modulation data including the light modulation pattern for the phase for each pixel.

9. The optical device of claim 3, wherein each of the plurality of first pixels comprises a first sub-pixel configured to emit a first light, a second sub-pixel configured to emit a second light, and a third sub-pixel configured to emit a third light, and
wherein the controlling the light source based on the light intensity data comprises:
determining an intensity of the first light emitted by the first sub-pixel, an intensity of the second light emitted by the second sub-pixel, and an intensity of the third light emitted by the third sub-pixel according to the light intensity data.

10. The optical device of claim 1, wherein the light source comprises a display device that is configured to output incoherent light.

11. The optical device of claim 10, wherein the light source comprises an Organic Light-Emitting Diode on Silicon (OLEDoS) display device that includes an organic light-emitting layer located on a first semiconductor substrate.

12. The optical device of claim 10, wherein the light source comprises a Light-Emitting Diode on Silicon (LEDoS) display device that includes an inorganic light-emitting layer located on a second semiconductor substrate.

13. The optical device of claim 1, wherein the spatial light modulator comprises a Liquid Crystal on Silicon (LCoS) display device that includes a liquid-crystal layer located on a third semiconductor substrate.

14. An optical device comprising:
a first display device comprising first pixels configured to emit light of a first color;
a second display device comprising second pixels configured to emit light of a second color different from the first color;
a first reflection member configured to reflect light of the first color while transmitting light of other colors than the first color;
a second reflection member configured to reflect light of the second color while transmitting light of other colors than the second color;
a spatial light modulator comprising third pixels configured to display a light modulation pattern to modulate a phase of light passing through the first reflection member and the second reflection member; and
a controller configured to control the first pixels, the second pixels, and the third pixels based on an input image.

15. The optical device of claim 14, wherein the first pixels, the second pixels, and the third pixels are associated with one another, respectively.

16. The optical device of claim 14, wherein the controller is further configured to:
generate target color data for each pixel color and target phase data for each pixel phase based on the input image,
generate target hologram data comprising information on the color for each pixel and information on the phase for each pixel by combining the target color data with the target phase data,
generate light intensity data for the color for each pixel and light modulation data for the phase for each pixel based on the target hologram data,
control the first display device and the second display device based on the light intensity data, and
control the spatial light modulator based on the light modulation pattern.

17. The optical device of claim 16, wherein the generating the light intensity data for the color for each pixel and the light modulation data for the phase for each pixel based on the target hologram data comprises:
extracting the light intensity data including the color for each pixel from the target hologram data; and
performing a function transformation on the target hologram data to generate the light modulation data including the light modulation pattern for the phase for each pixel.

18. The optical device of claim 16, wherein the controlling the first display device and the second display device based on the light intensity data comprises:
determining an intensity of the light of the first color emitted by a first pixel corresponding to a first position from among the first pixels and an intensity of the light of the second color emitted by a second pixel corresponding to a second position from among the second pixels according to the light intensity data.

19. The optical device of claim 14, further comprising:
a first refraction member arranged between the first display device and the first reflection member, and configured to collimate light of the first color output from the first display device to provide the light to the first reflection member; and
a second refraction member arranged between the second display device and the second reflection member, and configured to collimate light of the second color output from the second display device to provide the light to the second reflection member.

20. An electronic device comprising:
a light source comprising a plurality of first pixels configured to emit light;
a spatial light modulator comprising a plurality of second pixels configured to display a light modulation pattern to modulate a phase of light output from the light source;
a memory; and
a processor,
wherein the processor is configured to generate light intensity data for the plurality of first pixels and light modulation data for the plurality of second pixels based on an input image.
